(19) United States
(12) Patent Application Publication
(10) Pub. No.: US 2017/0347790 A1
(43) Pub. Date: Dec. 7, 2017

(54) ELECTRICAL TOOTH BRUSH DEVICE HAVING SUCTION AND RELATED KIT AND METHOD

(71) Applicant: Airway Medix S.A., Warsaw (PL)

(72) Inventors: Oron ZACHAR, Tel Aviv (IL); Yair RAMOT, Kfar Maas (IL); Eizik AMAR, Ashdod (IL)

(21) Appl. No.: 15/594,689

(22) Filed: May 15, 2017

Related U.S. Application Data
(63) Continuation-in-part of application No. 15/454,897, filed on Mar. 9, 2017.
(60) Provisional application No. 62/337,251, filed on May 16, 2016.
(60) Provisional application No. 62/305,706, filed on Mar. 9, 2016.
(60) Provisional application No. 62/305,821, filed on Mar. 9, 2016.
(60) Provisional application No. 62/305,993, filed on Mar. 9, 2016.

(51) Int. Cl. A46B 15/00; A46B 13/02; A61C 17/34; A46B 5/00; A61C 17/22; A46B 9/04

(52) U.S. Cl. CPC A46B 15/0053; A61C 17/221; A46B 9/04; A61C 17/3481; A61C 17/3436; A61C 17/222; A46B 5/0033; A46B 15/0044; A46B 13/023; A46B 2200/1066; A61C 2204/002

(57) ABSTRACT

An oral care system comprising: a. an electrical motor b. a base assembly comprising: i. an elongated base-assembly main body defining an elongate axis; and/or ii. a battery or a battery compartment optionally including electrical contacts for a battery, the battery and/or the battery compartment being electrically wired to the electrical motor; and c. a head assembly is disclosed herein. Methods and kits are also disclosed.

### CROSS-REFERENCE TO RELATED APPLICATIONS

The present application claims priority to the following patent applications, all of which are hereby incorporated by reference herein in their entirety: U.S. Provisional Application No. 62/336,793 filed on May 16, 2016 and U.S. Provisional Application No. 62/337,251 filed on May 16, 2016. The present application is also a continuation in part of U.S. Non-Provisional application Ser. No. 15/454,897 filed on Mar. 9, 2017 which is incorporated herein by reference in its entirety.

### DETAILED DESCRIPTION OF EMBODIMENTS

The following documents are incorporated herein by reference—U.S. Pat. No. 8,453,285, U.S. Pat. No. 6,766,548 and U.S. Pat. No. 6,920,659. Any feature or combination of features disclosed in any of The following documents are incorporated by reference—U.S. Pat. No. 8,453,285, U.S. Pat. No. 6,766,548 and U.S. Pat. No. 6,920,659 may be combined with any feature disclosed herein.

Embodiments of the present invention relate to systems, methods and kits for cleaning the oral cavity and/or teeth of a subject, including but not limited to an intubated subject.

The invention is herein described, by way of example only, with reference to the accompanying drawings. With specific reference now to the drawings in detail, it is stressed that the particulars shown are by way of example and for purposes of illustrative discussion of the preferred embodiments of the exemplary system only and are presented in the cause of providing what is believed to be a useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how several forms of the invention may be embodied in practice and how to make and use the embodiments.

For brevity, some explicit combinations of various features are not explicitly illustrated in the figures and/or described. It is now disclosed that any combination of the method or device features disclosed herein can be combined in any manner—including any combination of features—any combination of features can be included in any embodiment and/or omitted from any embodiments.

In relation to the figures the following numbers indicate:

### Elements of Brush Head Assembly 150

160—head main body
165—brush
170—suction lumen
270A—distal portion of suction lumen 170
270B—proximal portion of suction lumen 170
172—distal orifice of suction lumen 170
171—suction connector
166—head drive-shaft
164—brush transmission
162—head shaft lumen
199—proximal end of head shaft lumen
166—head drive-shaft
167 proximal-facing surface of head main body 160

### Elements of Brush Base Assembly 100

110 base main body
190A distal half of base main body
190B proximal half of base main body
116 motor
149 lumen-restrainer
138 suction switch
112 battery
188 electrical line
114 base drive-shaft
186 base shaft lumen
141, 142—indicators
140 on/off switch (of motor 116)
117 distal-facing surface of base main body 110

### Locations or Axes of Elements of Head Assembly 150

159—Elongate and/or central axis of head main body 160
173—Elongate Axis of the distal portion 270A of suction lumen 170
196—orientation axis of brush 165
103—orientation of suction distal orifice 172

### Locations or Axes of Elements of Base Assembly 100

181—Central and/or elongate axis of brush main body 110
131—more distal restraining location
137—more proximal restraining location

### Additional Elements or Locations or Axis

Stabilizing attachment 139
Shaft link 169
Suction source 200
187—proximal-distal direction
Interface plane 197

FIG. 1A illustrates a multi-assembly power-brush device for cleaning a subject's teeth where matter (e.g. debris or biofilm) is suctioned into and through a suction lumen 170 (e.g. via suction orifice 172 disposed at a distal end thereof). The power-brush comprises base 100 and head 150 assemblies where head assembly 150 (to which brush 165 is mounted) is detachably attached to a base assembly 100. Whenever the head assembly 150 becomes dirty or is otherwise discarded, the base assembly 100 can be reused with a new ‘replacement’ head assembly 150. As will be discussed below, head assembly 150 comprises head assembly main body 160 and base assembly 100 comprises head assembly main body 110.

FIG. 1B illustrates the same power brush when a proximal end of suction lumen 170 and/or suction connector 171 (e.g. tapered suction connector) at the suction lumen proximal end is coupled to a suction source 200. FIG. 2A-2C show the same brush as in FIG. 1A where certain elements or labels are removed to further emphasize the various lumens of the brush. In FIG. 2B, three lumen are illustrated—(i) head shaft lumen 162; (ii) base shaft lumen 186 and (iii) suction lumen 170. As shown in FIG. 2B, suction lumen 170 comprises a distal portion 270A and a proximal portion 270B.

FIG. 3 shows the same brush in a disassembled configuration—one salient feature shown in FIG. 3 (and in FIG. 4) is a ‘tail-like’ proximal portion 270B of suction lumen 170—e.g. proximally extending past main body 160 of head assembly 150. FIG. 5 defines a representative direction 196 of brush 165.

As shown in the figures, the power-brush device comprises head 150 and base 100 assemblies that are detachable attached to each other. The power-brush device cleans both (i) by motion (e.g. rotational and/or vibrational motion) of brush 165 (e.g. by dislodging material on the subject's teeth or gums)—for example, motion induced and/or sustained by an electric motor as known in the art of electric toothbrushes and (ii) by suctioning matter (e.g. debris, cleaning material such as toothpaste or cleaning fluids) into suction lumen 170 via one or more suction-orifice(s) 172 at a distal end of suction lumen 170 and disposed 172 on or alongside a main body 160 of head assembly. Towards this end, a source 200 of negative pressure is disposed at a proximal end suction lumen 170 (e.g. so that negative pressure is detachably attached to a proximate end of suction lumen 170 or to a suction connection 170).

### Potential Design Considerations Related to Some Embodiments

During use of the power-brush device, the head assembly 150 including brush 165 is mounted is typically more exposed to potentially-non-sterile material (e.g. debris or biofilm) than the base assembly 100. As will be discussed below, at least some of this potentially non-sterile material is also proximally transported, through a suction lumen 170) towards and then proximally past base assembly 100.

Embodiments of the present invention relate to two potentially-contradictory design considerations: (i) (DESIGN CONSIDERATION “A”) a desire to minimize exposure of the base assembly 100 to non-sterile material when this material is transported through suction lumen 170 around or past or through the base assembly 100 (ii) (DESIGN CONSIDERATION “B”) a desire to achieve this goal without sacrificing (or with at most a minimum sacrifice of) the overall ‘compactness’ of the power-brush device.

Without limitation and not wishing to be bound by theory, it is possible to achieve these goals by the following features:
I. Although the ‘tail-like’ proximal portion 270B of suction lumen 170 outwardly extends past a proximal end of head assembly mail body 160, the ‘tail-like’ proximal portion 270B of suction lumen 170 is part of the head assembly 150, rather than part of the base assembly 100. Thus, when the device is disassembled into ‘head 150’ and ‘base 100’ constituents (e.g. at a time when suction lumen is disconnected from suction source), the distal portion 270B of suction lumen 170 is detachable from the base-assembly main body 110 (i.e. so it is not directly or indirectly attached from the base-assembly main body 110) while remaining attached (i.e. directly or indirectly) to head-assembly main-body 160. Because the suction lumen 170 may be more exposed to non-sterile material than the base assembly 100, this feature is useful for allowing the potentially less-sterile suction lumen 170 to completely separate from the head-assembly main-body 160—this may be useful for design consideration ‘A.’
II. Furthermore, an interior of an entirety of the suction lumen 170 is liquid-sealed away from the base assembly main body 110. Once again, this protects the base assembly 100 from potentially non-sterile material as the potentially non-sterile material travels proximally through the suction lumen 170. This feature as well may be useful for design consideration ‘A.’
III. As shown in FIG. 1A-1C and 2A-2D, base assembly main body 110 is in “restraining” contact with the proximal portion 270B of the suction lumen 170 (e.g. ‘tail-like’ part of the suction lumen 170) via a ‘proximally disposed’ location 137 of base assembly main body 110. This ‘proximally’ disposed location 137 is disposed on the proximal half of the base assembly main body. The ‘restraining’ contact restrains at least sideways motion (illustrated in FIG. 2C) of the suction lumen 170 away from the base assembly main body 110. This may be useful for design consideration ‘B.’

Thus, in some embodiments, both the distal 270A and proximal 270B portions of the suction lumen may be completely brought out of contact from the base assembly main body 110 while remaining attached to each other and to the head-assembly main body 160;

### Discussion of Head 160 and Brush 160 Main Body

As noted above, the brush may be disassembled into head 150 and base assemblies. Head assembly 150 comprises a head assembly main body 160 ; base assembly 100 comprises base assembly main body 110.

In some embodiments, head main body 160 is elongate. Axis 159, illustrated in FIG. 1A, is an elongate and/or central axis of head main body 160. In some embodiments, base main body 110 is elongate. Axis 181, illustrated in FIG. 1A, is an elongate and/or central axis of base main body 110. As illustrated in the drawings, when the head 150 and base 100 assemblies are in the ‘attached’ configuration (i.e. so that motor 116 drives rotational and/or vibrational motion of brush 165—e.g. via coupled drive shafts 114, 166), then (i) elongate and/or central axis 159 of head main body and (ii) Central and/or elongate axis 181 of brush main body 110 are generally parallel to each other (e.g. possibly but not necessarily co-linear with each other) and aligned with an overall “Distal-proximal” axis 187.

As is common in the art of power toothbrushes, when the power brush is assembled and during operation thereof, head main body 160 is located distal to a brush main body 110.

In some embodiments and as illustrated in FIG. 1A, a proximal location of head main body 160 is attached to a distal location of base main body 110 via stabilizing attachment(s) 139. Stabilizing attachment or any portion thereof may be part of head assembly 150, of base assembly 100, of a combination thereof, or of neither. As is common in the art of the electric toothbrushes, preferably base assembly main body 110 and head assembly main body 160 are rigidly attached to each other. Even though the attachment is rigid, it is reversible to allow for base re-use (i.e. with a new head). As is well-known in the art of the electric toothbrushes, the rigid attachment allows the user to precisely control a location and/or orientation or brush 165 which is mounted (e.g. permanently mounted) to head main body 160.

Any attachment mechanism may be employed—for example, any mechanical mechanism (e.g. fastener, snap, or magnetic mechanism).

Illustrated in FIG. 3 is (i) distal-facing surface 117 of base main body 110; and (ii) proximal-facing surface 167 of head main body 160. The head assembly 150 is detachably attachable to the base assembly such that when the head and base assemblies 150, 100 are attached to each these two surfaces 117, 167 face each other—e.g. in contact with each or facing each other with a gap (for example, a relatively ‘small’ gap of at most 5 mm or at most 3 mm or at most 1 mm) separating between these two surfaces 117, 167.

FIG. 1C shows interface plane 197. Interface plane 197 necessarily is perpendicular to distal-proximal axis 187 and is obtained by (i) computing the best plane (i.e. plane constrained to be perpendicular to distal-proximal axis 187) of a mediating surface (i.e. halfway between) the i) distal-facing surface 117 of base main body 110; and (ii) proximal-facing surface 167 of head main body 160. Interface plane 197 is also illustrated in FIG. 2D.

### Driving Motion of Brush 165

As is known in the art of electric toothbrushes and in the non-limiting example of the drawings, motion (e.g. vibrational and/or translational motion) of brush 165 may be provided by the following elements in combination with each other: (i) head-drive shaft 166, at least a portion of which is within head shaft lumen 162; (ii) base-drive shaft 114 at least a portion of which is within base shaft lumen 186; (iv) shaft link 169 (v) brush shaft transmission 164; (vi) electric motor 116 and (vi) battery 112.

Electric motor 116 (e.g. electrically powered by current received from battery 112 via electric line 188) forces longitudinal motion (e.g. reciprocating motion) base shaft drive shaft 114 within base shaft lumen 186. In some embodiments, motor 116 is disposed within the base-assembly main body 110.

Because base shaft drive shaft 114 is rigidly attached to head-drive shaft 166 (e.g. detachably attached and/or attached via shaft link 169), this longitudinal motion of base drive shaft 114 causes longitudinal motion of head-drive shaft 166 in head shaft lumen 162. There is no requirement for an entirety of base shaft drive shaft 114 to be within base shaft lumen 186—in some embodiments, only a portion of base shaft drive shaft 114 is disposed within base shaft lumen 186 (e.g. so a distal portion of base shaft drive shaft 114 distally protrudes from base shaft lumen 186). In fact, this is the situation illustrated in FIG. 1A where a portion of base drive shaft 114 is disposed within head shaft lumen 162—in addition, in the example of FIG. 1A shaft link 169 is disposed in head shaft lumen 162.

There is no requirement for an entirety of head shaft drive shaft 166 to be within head shaft lumen 162—in some embodiments (NOT SHOWN), only a portion of head shaft drive shaft 166 is disposed within head shaft lumen 162 (e.g. so a proximal portion of head shaft drive shaft 166 proximally protrudes from head shaft lumen 162—for example, past a proximal end 199 of head shaft lumen.

As noted above, motor 116 is mechanically coupled to head drive-shaft 166 (e.g. via base drive shaft 114 and shaft link 169) to induce longitudinal motion (e.g. reciprocating motion) of head drive-shaft 166. In some embodiments and as is well-known in the art of electrical toothbrushes, this longitudinal motion is converted into vibrational and/or rotational motion of brush 165—e.g. head drive-shaft 166 is mechanically coupled to brush 165—for example, via brush transmission 164.

In some embodiments, head-assembly shaft lumen 162 has a length L₁ of which alongside is or formed within the head-assembly main body 160 and oriented along the elongate and/or central axis 159 thereof.

### Suction Lumen 170

In some embodiments, in addition to conventional ‘electrical toothbrush’ functionality, the power toothbrush provides a ‘suctioning functionality’—for example, to remove matter (e.g. debris or biofilms) from the subject's mouth.

As illustrated in the figures, suction orifice 172 is a distal opening of suction lumen 170—thus suction lumen 170 may be said to define a distal suction-orifice 172 disposed at a distal end of suction lumen 170.

As shown in FIG. 1B, when a proximal end of suction lumen 170 is connected to suction source 200 (for example, via connected 171) negative pressure is transmitted from suction source 200 via suction lumen 170 to a region outside of suction orifice 172. This induces a flow of air and optionally additional material (e.g. potentially non-sterile material) into suction lumen 170 via suction orifice 172. In particular, this transmitted negative pressure causes this potentially non-sterile material to entered into suction lumen 170 via suction orifice 172, traverse the suction lumen 170 (i.e. an interior thereof) and to proximally exit the suction via a proximal end of suction lumen 170.

In some embodiments, at the other end (i.e. proximal end) of suction lumen 170 is suction connector 171—for example, the proximal end of suction lumen 170 is connected via the suction connector 171. In some embodiments, suction connector 171 is a tapered connector, tapered in the proximal direction. Suction connector 171 may be permanently attached to suction lumen 170 (e.g. integrally formed with) or detachable attached to suction lumen 170 at a proximal end thereof. For example, a kit may comprise suction lumen 170 and suction connector 171 as separate elements and the suction connector 171 is attached to (e.g. mounted onto) suction lumen 170 at a proximal end thereof.

As shown in FIG. 2B, suction lumen 170 comprises a distal portion 270A and a proximal portion 270B. For example, the distal portion 270A is disposed within or alongside the head-assembly main body 160 (e.g. suction lumen 170 longitudinally spans at least a majority (e.g. at least 75% of) of head-assembly main body 160 (i.e. a length thereof)). As shown in FIG. 1D, when the head 150 and base 100 assemblies are coupled to each other, the distal portion 270B of suction lumen 170 is distal to interface plane 197.

By definition, proximal portion 270B that is located proximal to the distal portion 270A. As shown in FIG. 1D, when the head 150 and base 100 assemblies are coupled to each other, the proximal portion 270A of suction lumen 170 is proximal to interface plane 197. In some embodiments, at least 75% or at least 90% of an entirety of the entire proximal portion 270B is proximal to a proximal end 199 of head shaft lumen 162. In some embodiments, at least 75% or at least 90% of an entirety of the entire proximal portion 270B is proximal to interface plane 197

In some embodiments, the proximal 270B and distal 270A portions of the suction lumen 170 are permanently attached to each other. Alternatively, they are detachably attachable to each other.

Head-assembly shaft lumen 162 has a length L₁ of which alongside is or formed within the head-assembly main body 160 and oriented along the elongate and/or central axis 159 thereof.

In some embodiments, L₂ is a length of distal portion 270A of suction lumen 170, L₃ is a length of proximal portion 270B of suction lumen 170.

In some embodiments, a length ratio L₃/L₁ is at least 0.5 or at least 0.75 or at least 1 or at least 1.25 or at least 1.5. Alternatively or additionally, a ratio (L₂+L₃)/L₁ is at least 1 or at least 1.25 or at least 1.4 or at least 1.5 or at least 1.75 or at least 2.

In some embodiments, A. the proximal portion of the suction lumen is: i. attached to both the distal portion of the suction lumen and to the brush-head main body; and can remain attached to the head main body 160 while being detached from the base main body.

### A Discussion of Brush 165

Also illustrated in the figures is a sideways-facing brush 165 mounted to the head-assembly main body 160—for example, mounted to a distal half of head-assembly main body 160. As will be discussed below, bristles of the brush 165 collectively defining a bristle-alignment direction 196.

As is known in the art of toothbrushes, brush 165 comprises an array of bristles—in non-limiting embodiments, a width of each bristle is at most 0.25 mm or at most 0.1 mm and/or length of each bristles is at most 2 cm or at most 1.5 cm or at most 1 cm.

In some embodiments and as illustrated by brushes 165A (schematic illustration) and 165C (more accurate illustration of an actual brush) of FIG. 5, the bristles are parallel to each other—in these cases all bristles are aligned both with each other and also with brush orientation axis 196 defining a representative orientation/direction (e.g. average orientation/direction) of the bristles of the brush. In other examples, and as illustrated by brushes 165B (schematic illustration) and 165D (more accurate illustration of an actual brush) of FIG. 5, the bristles are not necessarily parallel to each other—however, even in this situation the bristles collectively define a brush orientation axis 196 which is a representative orientation/direction (e.g. average orientation/direction) of the bristles of the brush.

As illustrated in the figures, brush 165 (i.e. whose orientation is defined by brush orientation axis 196) is sideways-facing relative to a proximal-distal and/or to a central axis 159 of the head main body 160.

One salient feature provided by some embodiments of the invention relates to relative orientations of (i) orientation vector 173 of distal suction-orifice 172 (discussed above); and (ii) bristle-alignment direction 196. In some embodiments, orientation vector 173 is non-parallel to bristle-alignment direction 196 so that an angle α between orientation vector 173 and bristle-alignment direction 196 is non-zero. In different embodiments, this angle α is at least 10 degrees or at least 20 degrees or at least 30 degrees. For the present disclosure, if this angle is defined as at least “X” degrees (where “X” is a positive number less than 90) this means that the angle α is between “X” degrees and 90 degrees.

In the particular example illustrated the drawings, orientation vector 173 and bristle-alignment direction 196 are perpendicular to each other.

### Indication of Time Since Most Recent Use

In some embodiments, the device includes a display assembly (e.g. a display screen or a plurality of indicators—e.g. 141/142 which may be mounted to the base as shown in the drawings or to the head—in another example, the display assembly is mounted to a one-piece electric toothbrush or any toothbrush that does not rely on the head/base that are detachable from each other).

Immediately after use (i.e. after the motor is shut off), the display assembly has a first mode—e.g. a ‘green’ indicating that the brush was last used relatively recently and that there is no current need to brush the subject's teeth. At a later time, the display assembly may indicate that the amount of time since the most recent use is ‘too long’ (e.g. exceeded some sort of pre-set threshold—e.g. about 6 hours or about 8 hours or about 10 hours). At that point, the display assembly may transition from the first mode (e.g. green indicating that ‘the situation is good’ and that there is no need to brush teeth) to a second mode (e.g. red indicating that in fact there is need to operate the brush again to brush the subject's teeth). Thus, in some embodiments, timing circuitry (NOT SHOWN) (e.g. implemented as analog or digital electronics and/or in software) measures the elapsed time since the most recent brush use—e.g. the most recent time since the motor was shut off (e.g. by a user control such as a switch 140 which may be located anywhere—e.g. on base main body 110 or on head main body 160 or anywhere on a multi-piece or single piece electrical toothbrush). Thus in one example, in response to the user shutting off the motor (e.g. using a manual switch or in any other manner—e.g. a user puts down the brush and a sensor responds by shutting off the motor), the timing circuitry ‘begins’ to count the elapsed time since this happened.

In the example of FIG. 1A there are multiple LEDs—alternatively a single LED may change colors, or a display screen may be provided.

Until the amount of time reaches a threshold (e.g. immediately after brush usage), the display assembly may remain in a first state (e.g. green LED illuminated. Once the amount of time exceeds a threshold (e.g. a pre-determined value) (e.g. as measured by timing circuitry) this may be detected and in response the display assembly may perform a display transition—e.g. a red LED is shut off and a green LED turned on, or the LED color changes, or the display screen adopts a new state.

In some embodiments, display control circuitry (e.g. operatively linked to the timing circuitry to receive input therefrom) regulates a display state of the display screen.

In some embodiments, the timing circuitry and/or display control circuitry receives power from the battery even when the motor is shut off. For example, a switch may have 3 mode—(i) motor on [MODE A] (ii) entire device off (i.e. including timing and/or display control circuitry [MODE B] and (iii) motor off but circuitry receiving power from the battery and on (e.g. display optionally on) [MODE C]. In another example, there may be only two modes—MODES A and C without MODE B where the only way to get MODE B is to disconnect the battery.

Although this ‘display assembly’ and ‘display mode’ invention is explained in the context of a toothbrush having a head and a base, it is appreciated that his may apply to any electrical toothbrush including those having a suction lumen and those lacking a suction lumen.

### Discussion of FIG. 6

In some embodiments, the device is bendable—e.g. instead of an elongate and/or central axis 181 of base main body 110 remaining aligned with (e.g. parallel to) an elongate axis 159 of head main body 160, they can bend and/or pivot relative to each other.

For example, the head drive shaft 166 and the base drive shaft 114 are connected to each other via shaft link 169, and the shaft link 169 is configured to allow pivoting in a direction perpendicular to the both of the respective elongate axes of the head drive shaft 166 and the base drive shaft 114. FIG. 6 shows bending and/or pivoting (e.g. around shaft link 169) by an angle alpha.

### Note About Motor 116 and Brush Transmission 164

In the example of FIGS. 1-6 rotation of shafts 114, 166 is driven by motor 116—shaft 166 is coupled to transmission 164 to drive motion of brush 165.

This is not a limitation. In the example of FIGS. 9-21, the head assembly may include a proximal-facing sleeve or cavity 177, and a distal part of the base assembly is inserted into the proximal-facing sleeve or cavity 177. Mounted to or within the distal part of the base assembly is a vibrator 109 device comprising:
A. an electrical motor 116;
B. a shaft 89 that is part of the electrical motor and/or mechanically coupled to the electrical motor;
C. an offset/non-symmetric mass 181 attached to the shaft so that operation of the electrical motor causes the offset/non-symmetric mass to rotate around an elongate axis of the shaft to product vibrations,

In an alternative example (NOT SHOWN), the offset/non-symmetric mass is within or on the head main body.

In the example of FIGS. 9-21, the offset/non-symmetric mass 181 is on the base main body 110—a distal part of the base main body may be inserted see frame sequence of FIG. 12) into a proximal-facing ‘sleeve’ or cavity 177 defined by the head main body 160. This would bring the vibrator 109 into proximity with the brush 165 so that operation of the vibrator can better drive motion of brush 165—see FIG. 14 which illustrates distally travelling vibrations from the vibrator 109 that drive motion of the brush 165.

In some embodiments, the base may be modified to provide a degree of flexiblity—thus, it may not be necessary to rely on shaft link 169. For example, elastic neck 189 may provide at least 10 degrees or at least 20 degrees of flexibility—see FIGS. 18-19.

Some embodiments relate to a base assembly of an oral care system comprising:
i. an elongated base-assembly main body 110, at least a portion of which is elastic, the elongated base-assembly main body 110 defining an equilibrium-configuration elongate axis 181; and
ii. a vibrator device mounted in or on the elongated base-assembly main body 110, the vibrator device including:
   D. an electrical motor 116;
   E. a shaft that is part of the electrical motor and/or mechanically coupled to the electrical motor;
   F. an offset/non-symmetric mass attached to the shaft so that operation of the electrical motor causes the offset/non-symmetric mass to rotate around an elongate axis of the shaft to product vibrations,
the shaft of the vibrator device being aligned with the elongate axis 181 of the main body and the offset/non-symmetric mass located at a distal end of the base-assembly main body 110, at least a portion of the elongated base assembly main body being sufficiently elastic so that:
   A. when the elongated base-assembly main body 110 is the equilibrium configuration, line-segment between (A) fixed point on a proximal half of the elongated base-assembly main body 110 and (B) the offset/non-symmetric mass is aligned with the elongate axis 181 of the elongated base-assembly main body 110; and
   B. the elongated base-assembly main body 110 elastically bends without breaking to allow a direction of the line-segment to deviate from a direction of the equilibrium-configuration elongate axis 181 by at least 10 degrees or at least 20 degrees or at least 30 degrees.

FIG. 9A illustrates a head assembly. Within and/or alongside head main body 160 both the fluid delivery lumen 214 and the suction lumen 170 are disclosed alongside each other (e.g. aligned with elongate axis 159 of the head main body 160).

At a location distal thereto, there may be a fork 87 such that: (i) distal to the fork 87, the fluid delivery lumen 214 and suction lumen 170 are alongside each other and generally aligned with each other while (ii) at the fork 87 (and proximal thereto), the respective directions of fluid delivery lumen 214 and suction lumen 170 diverge from each other.

In some embodiments (see FIG. 9B) reservoir 120 is part of the head assembly 150—e.g. it may be attached (for example, permanently attached) to fluid delivery lumen 214 and/or head main body 160 may being completely detached from base assembly.

Nevertheless, base main body 110 may define a compartment or recess that is dimensioned to store reservoir 120—see, for example, FIGS. 20A-20B. For example, a spring assembly for expelling liquids from reservoir 120 may be present in or on base main body 110.

### BRIEF DESCRIPTION OF THE DRAWINGS

FIG. 1A illustrates a multi-assembly power-brush device for cleaning a subject's teeth where matter (e.g. debris or biofilm) is suctioned into and through a suction lumen.

FIG. 1B illustrates the same power brush when a proximal end of suction lumen and/or suction connector is coupled to a suction source.

FIG. 1C illustrates an interface plane.

FIGS. 2A-2C show the same brush as in FIG. 1A where certain elements or labels are removed to further emphasize the various lumens of the brush.

FIG. 2D illustrates an interface plane.

FIG. 3 shows the same brush in a disassembled configuration.

FIG. 4 illustrates a ‘tail-like’ proximal portion of suction lumen.

FIG. 5 defines a representative direction of the brush.

FIG. 6 illustrates the device as bendable instead of an elongate and/or central axis of base main body.

FIG.7 illustrates the fluid delivery distal orifice and fluid delivery lumen and reservoir where fluid is stored.

FIG. 8 illustrates the toothbrush bristles, top and side view.

FIG. 9A illustrates a head assembly.

FIG. 9B illustrates part of the head assembly.

FIG. 10 illustrates a head assembly.

FIG. 11A illustrates a base assembly.

FIG. 11B illustrates a base assembly.

FIG. 11C illustrates a base assembly.

FIG. 12 illustrates a frame sequence of distal part of the base main body that may be inserted into a proximal-facing ‘sleeve’ or cavity defined by the head main body.

FIG. 13 illustrates a distal part of the base main body.

FIG. 14 illustrates distally travelling vibrations from the vibrator 109 that drive motion of the brush.

FIGS. 15-17 illustrate a head and base assembly.

FIGS. 18A, 18B, 18C, and 19 illustrates flexibility of the head (elastic neck).

FIGS. 20A-20B illustrate a compartment or recess that is dimensioned to store reservoir—a spring assembly for expelling liquids from reservoir.

FIGS. 21A-21B illustrate an open and closed view of a compartment or recess that is dimensioned to store reservoir—a spring assembly for expelling liquids from reservoir.

What is claimed is:

1. An oral care system comprising:
a. an electrical motor 116;
b. a base assembly 100 comprising:
i. an elongated base-assembly main body 110 defining an elongate axis 181; and/or
ii. a battery or a battery compartment optionally including electrical contacts for a battery, the battery and/or the battery compartment being electrically wired to the electrical motor 116;
c. a head assembly 150, the head assembly comprising:
i. an elongated head-assembly main body 160 defining an elongate axis 159 thereof;
ii. a sideways-facing brush 165 mounted to the head-assembly main body 160 in a distal half thereof;
iii. a suction lumen 170 defining a distal suction-orifice 172, the suction lumen comprising:
A. a distal portion 270A disposed within or alongside the head-assembly main body 160 to longitudinally span a majority thereof; and
B. a proximal portion 270B that is located proximal to the distal portion 270A,
the head assembly 150 being detachably attachable to the base assembly such that when the head and base assemblies 150, 100 are attached to each other:
I. the head-assembly main body 160 is disposed distal to the base-assembly main-body 110; and
II. the brush is mechanically coupled to the motor 115 so that operation of the motor drives rotation and/or vibration of the sideways-facing brush 165;
wherein:
i. both the distal 270A and proximal 270B portions of the suction lumen may be completely brought out of contact from the base assembly main body 110 while remaining attached to each other and to the head-assembly main body 160;
ii. when the head and base assemblies 150, 100 are attached to each other:
A. the proximal 270B portion is within and/or disposed alongside the base assembly main body 110 and longitudinally spans at least a majority thereof;
B. an interior of an entirety of the suction lumen 170 is liquid-sealed away from the base assembly main body 110; and
C. the base assembly main body 110 is in restraining contact with the proximal portion 270B of the suction lumen 170 via a location 137 disposed on the proximal half of the base assembly main body, so as to restrain at least sideways motion of the suction lumen 170 away from the base assembly main body 110 at the location 137.

2. The system of claim 1 wherein: (i) brush bristles of the brush 165 collectively define a bristle-alignment direction 196; and (ii) at an orientation vector 173 of the distal suction orifice is non-parallel to the bristle-alignment direction 196 by at least 10 degrees or at least 20 degrees or at least 30 degrees.

3. The system of any preceding claim wherein the motor 116 is disposed within the base-assembly main body.

4. The system of claim 3 further comprising:
d. a head shaft lumen 162 at least a portion of which is along or disposed within the head main body 160;
e. a head drive shaft 166 at least a portion of which is disposed within the head shaft lumen 162, the head drive shaft mechanically coupled to the brush so that motion (e.g. rotational motion) head drive shaft drives the rotation and/or vibration of the sideways-facing brush 165;
f. a base shaft lumen 186 at least a portion of which is along or disposed within the base main body 110;
g. a base drive shaft 114 at least a portion of which is disposed within the base shaft lumen, the base drive shaft being mechanically coupled to the electrical motor so that operation of the electrical motor drives motion (e.g. rotational motion).

5. The system of claim 4 further comprising a shaft link 169 (e.g. part of the head drive shaft or the base drive shaft) via which the head drive shaft 166 and the base drive shaft 114 are connected to each other.

6. The system of claim 5 wherein when the head drive shaft 166 and the base drive shaft 114, the shaft link 169 is configured to allow pivoting in a direction perpendicular to the both of the respective elongate axes of the head drive shaft 166 and the base drive shaft 114.

7. The system of any preceding claim further comprising a suction lumen connector 171 (e.g. tapered) reversibly connectable to a proximally-disposed source 200 of suction to the suction lumen 170 so that when connected, suction is transmitted from the suction source to the distal suction-orifice 172 via an interior of the suction lumen 170,

8. The system of any preceding claim further comprising a suction source proximally disposed to the suction lumen and connected to the suction lumen via a proximal end thereof.

9. A method of cleaning teeth of a subject within the subject's mouth, the method comprising providing the system of any preceding claim, inserting the brush into the subject's mouth, operating the motor to drive rotational and/or vibrational motion of the brush to brush the subject's teeth, and operating the suction source to transmit negative pressure via the suction lumen to suction matter into the suction lumen via the distal suction orifice 172.

10. The method of any preceding claim further comprising timing circuitry configured to measure an elapsed-time-since-most-recent-operation since the motor was last on to drive rotation and/or vibration of the brush.

11. The method of any preceding claim further comprising an electronically operated display assembly (e.g. a plurality of LEDs and/or a display screen) having first and second display modes.

12. The method of any preceding claim further comprising
e. display-control circuitry configured to cause the display assembly to operate in the first or second display modes according to an elapsed-time-since-most-recent-operation, as measured by the timing circuitry, since the motor was last on to drive rotation and/or vibration of the brush.

13. The system of claim 1 wherein the display assembly comprises a red LED and a green LED such that (i) when the display assembly is in the first display mode the red LED is on and the green LED is off and (ii) when the display assembly is in the first display mode the red LED is off and the green LED is on.

14. The method of claim 3 wherein the pre-determined threshold value is at least 2 hours or at least 4 hours or at least 6 hours and/or at most 24 hours or at most 12 hours or at most 10 hours.

15. The system of any preceding claim further comprising a user control for turning on or turning off the electrical motor and wherein the timing circuitry detects a change of state of the user control.

16. The system of claim 15 wherein the user control is a mechanical switch having first and second switch-states and the timing circuitry measures an elapsed time since the user control was in a given one of the switch-states configured to cause the motor to operate.

17. The system of claim 15 wherein the user control is a mechanical switch having first and second switch-states and the timing circuitry measures an elapsed time since the user control was in a given one of the switch-states configured to cause the motor to operate.

18. The system of claim 15 wherein the user control is a mechanical switch having first and second switch-states and the timing circuitry measures an elapsed time since the user control was in a given one of the switch-states configured to cause the motor to operate.

19. The system of claim 15 wherein the user control is a mechanical switch having first and second switch-states and the timing circuitry measures an elapsed time since the user control was in a given one of the switch-states configured to cause the motor to operate.

20. The system of any preceding claim wherein the display-control circuitry causes the display assembly to perform a mode transition from the first to the second display modes to the second of the display modes in response to the elapsed-time-since-most-recent-operation exceeding a pre-determined threshold value.

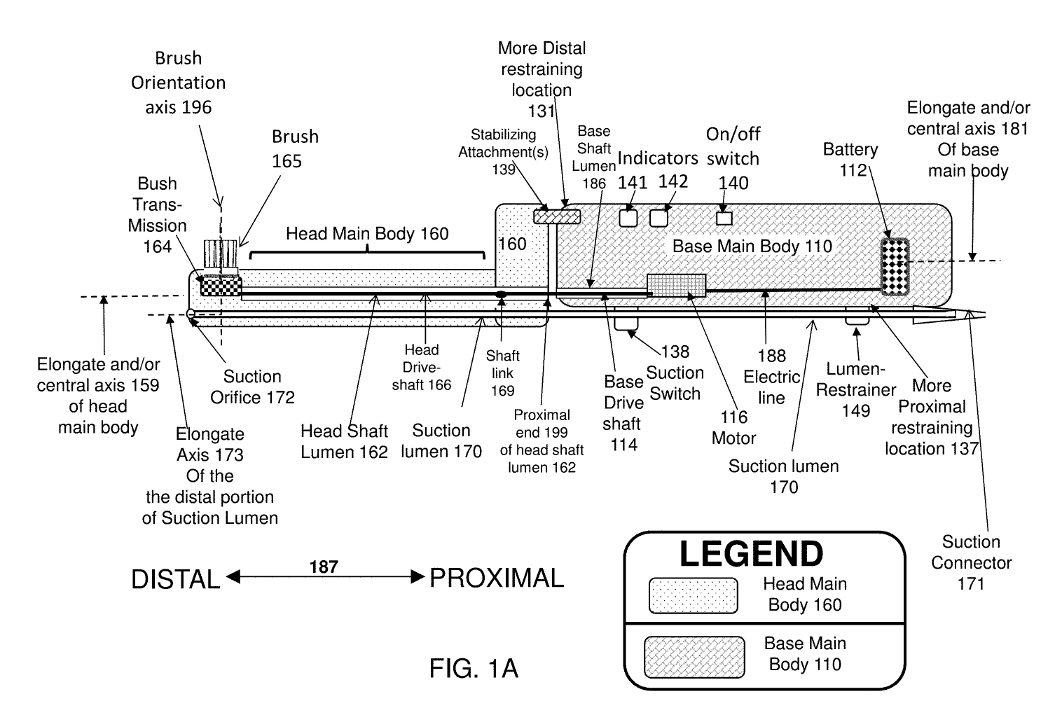

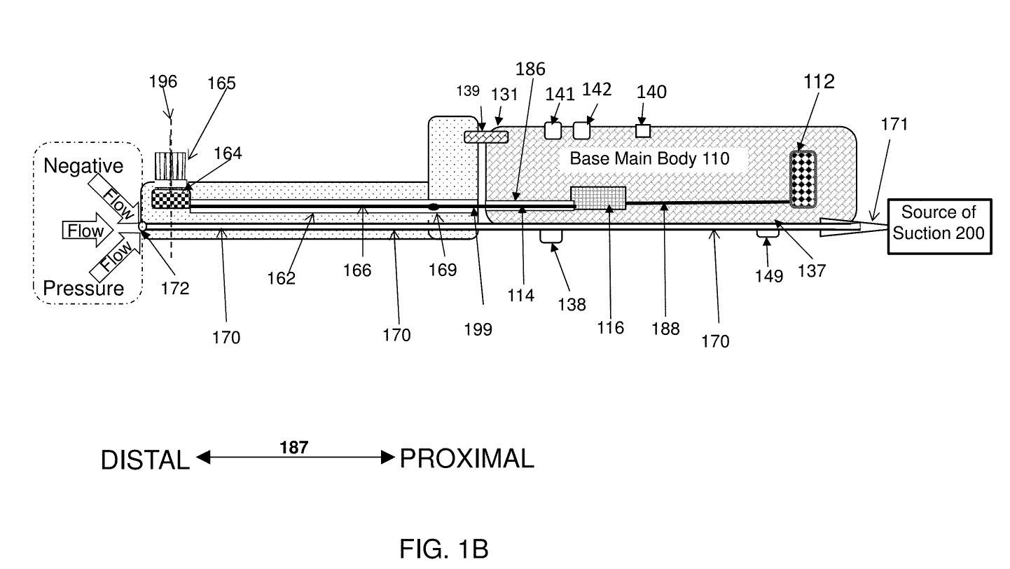

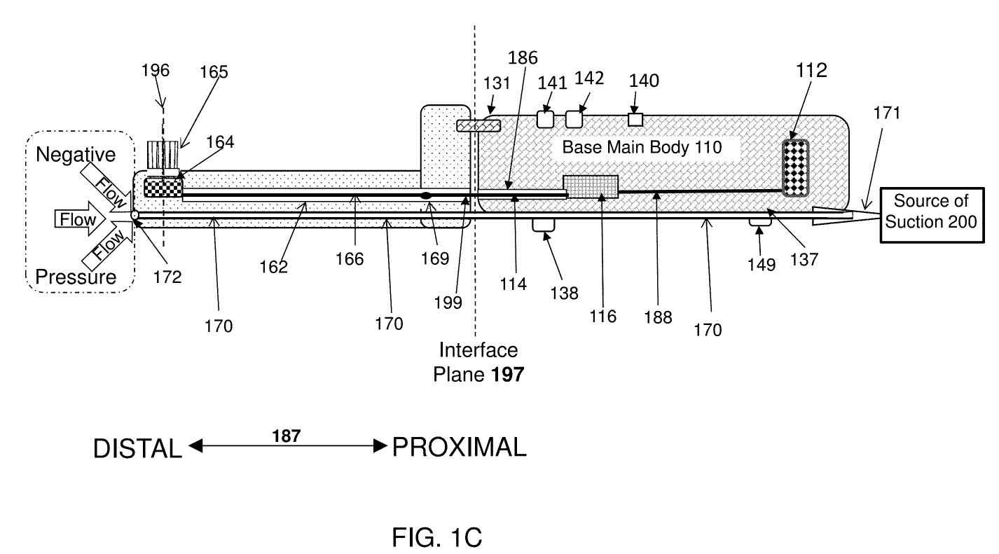

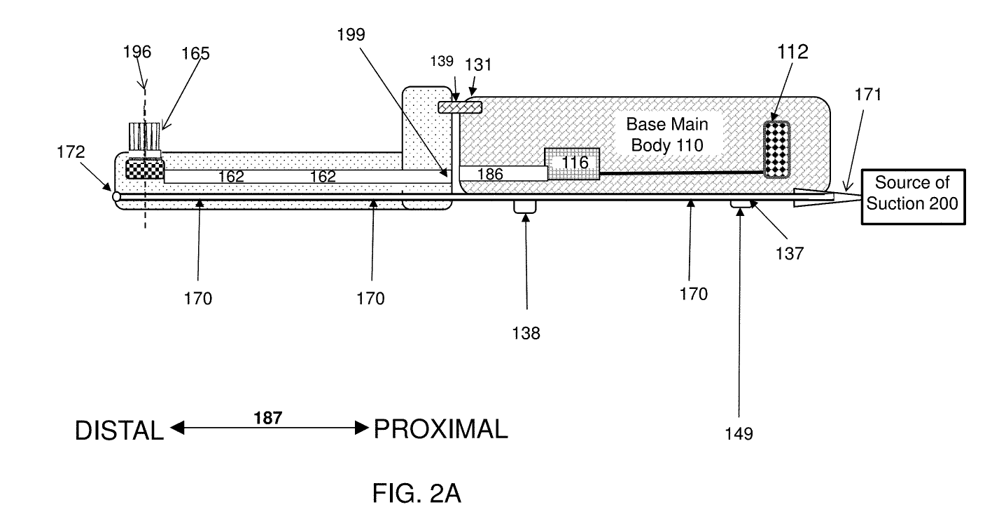

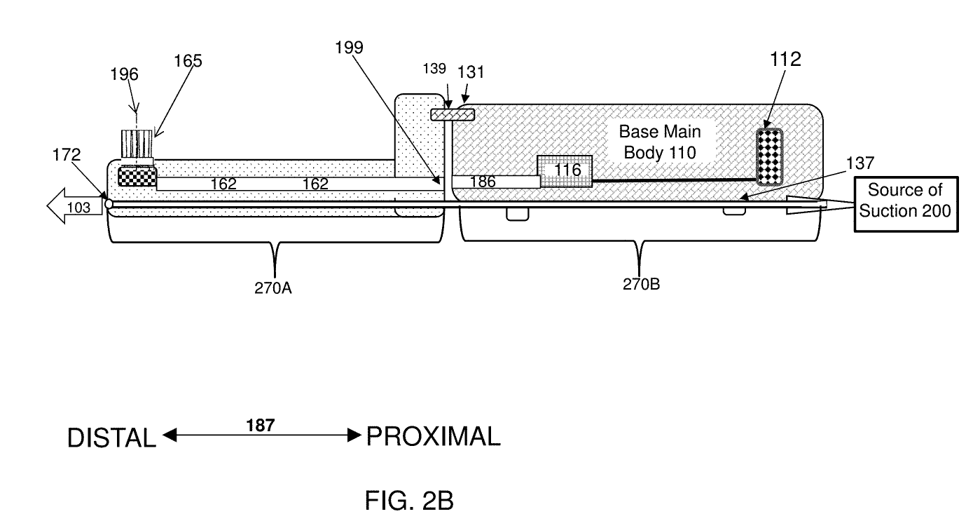

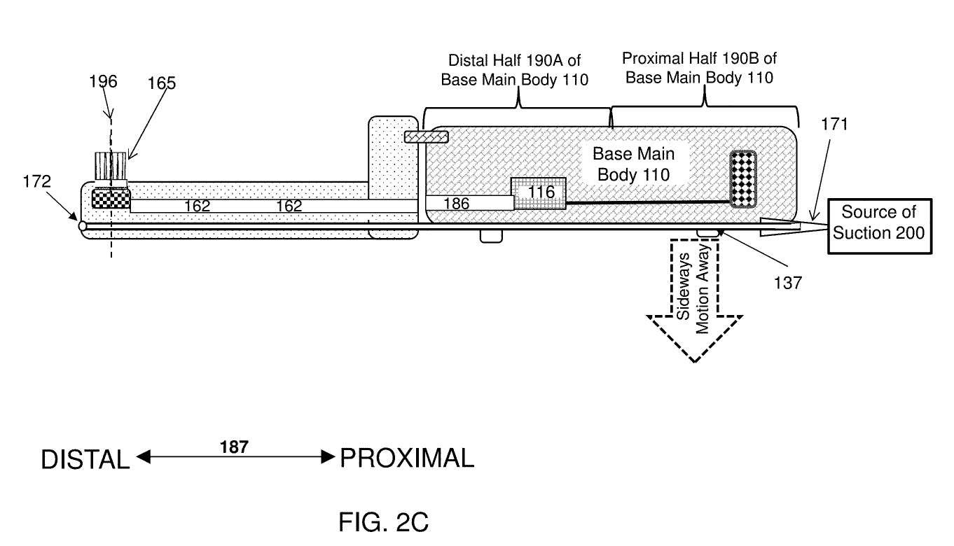

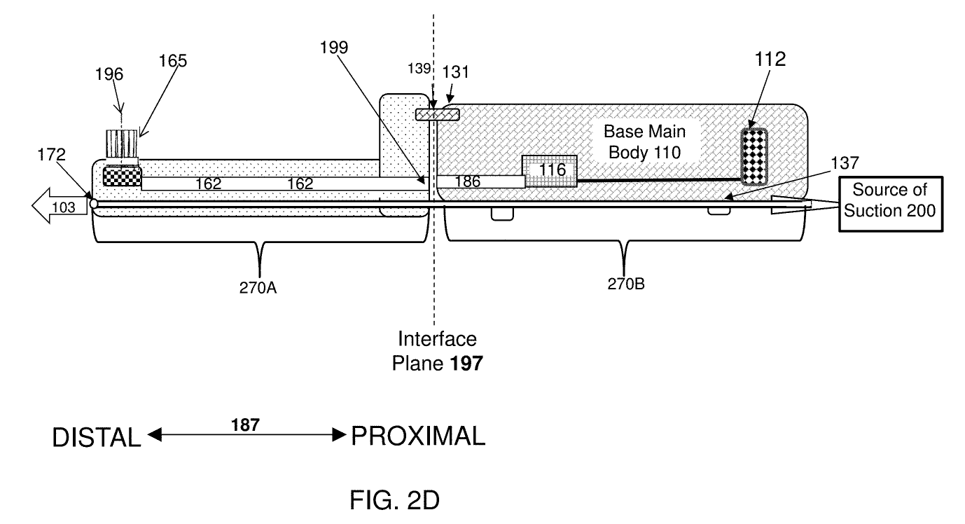

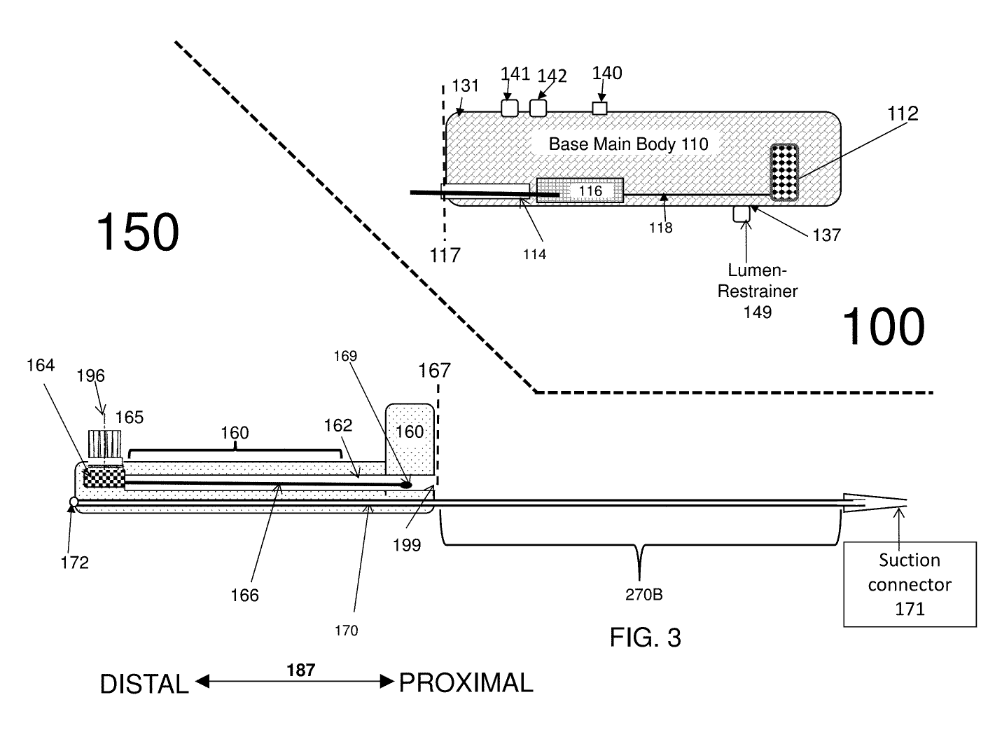

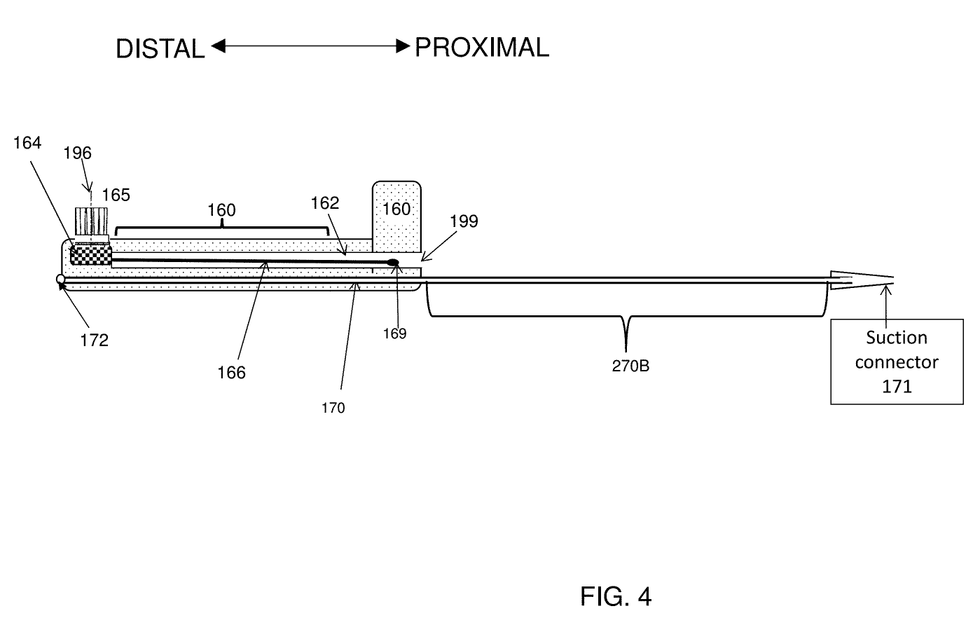

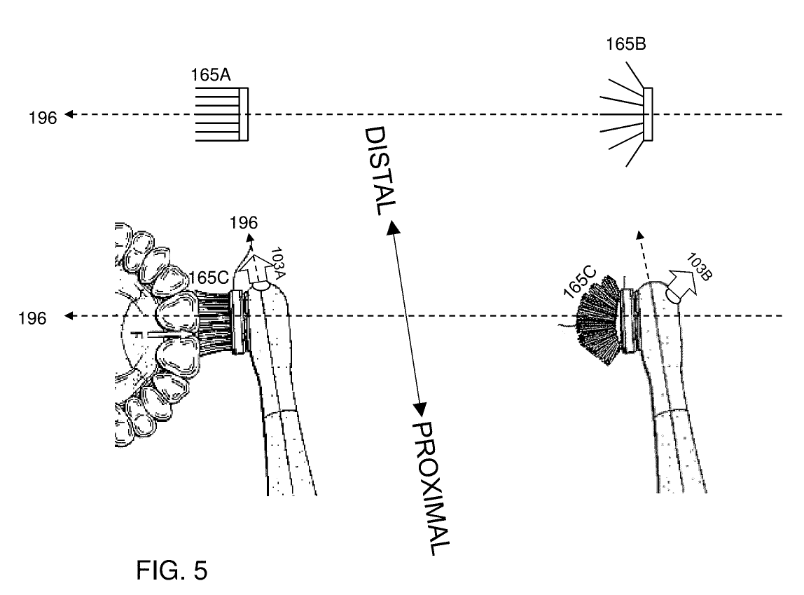

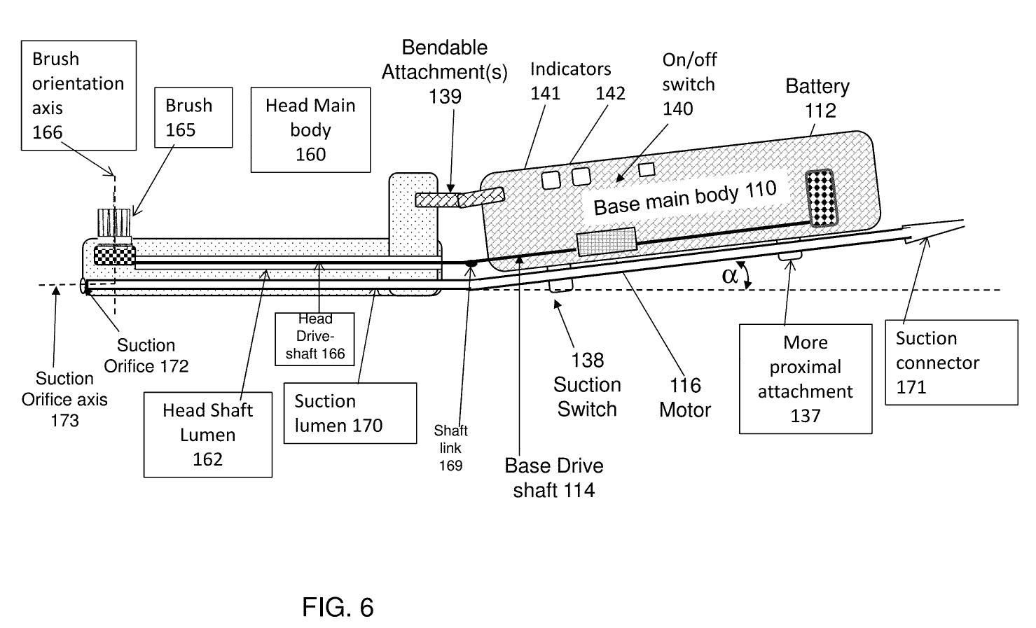

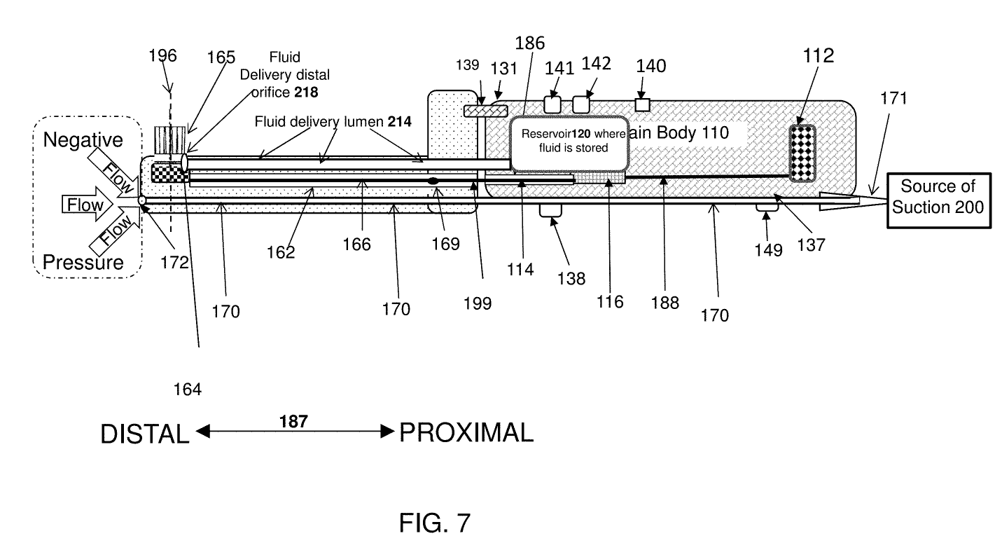

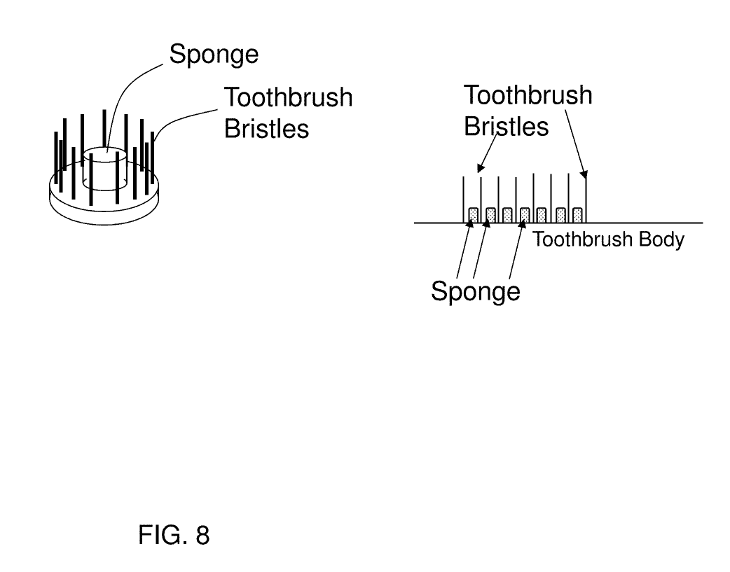

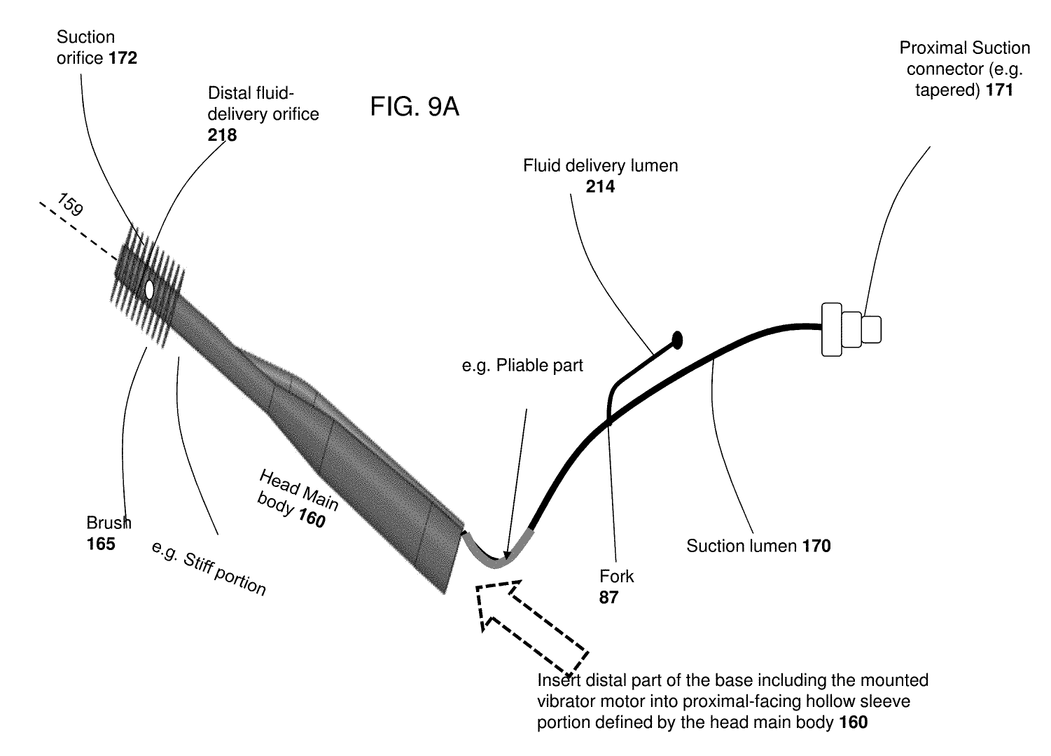

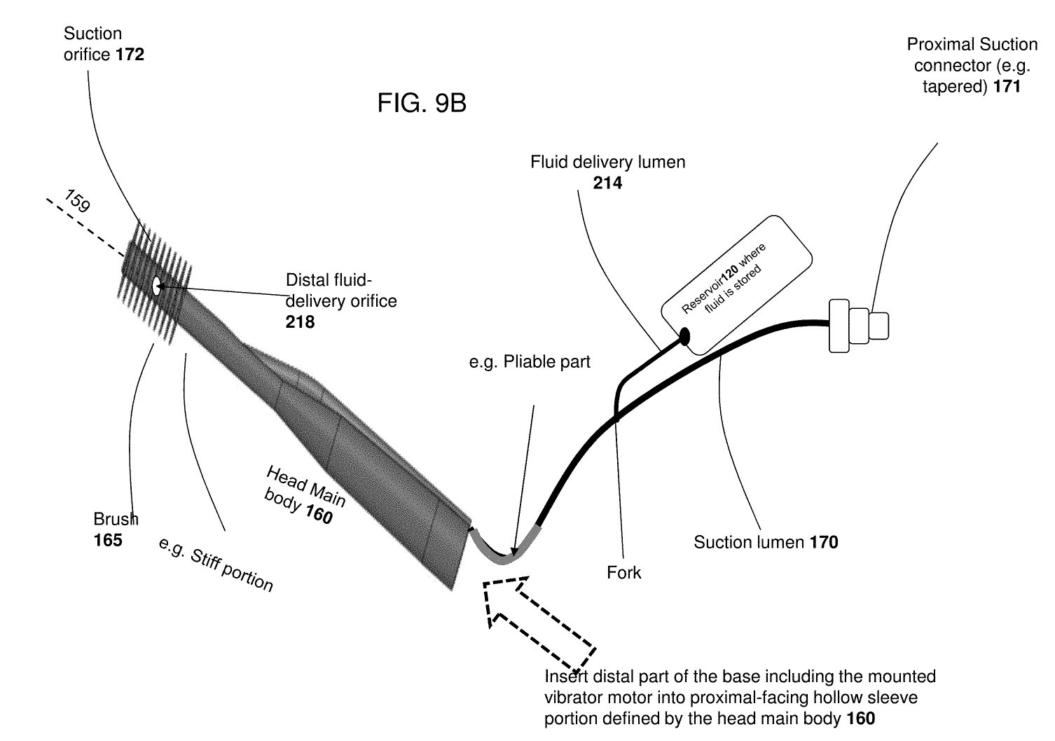

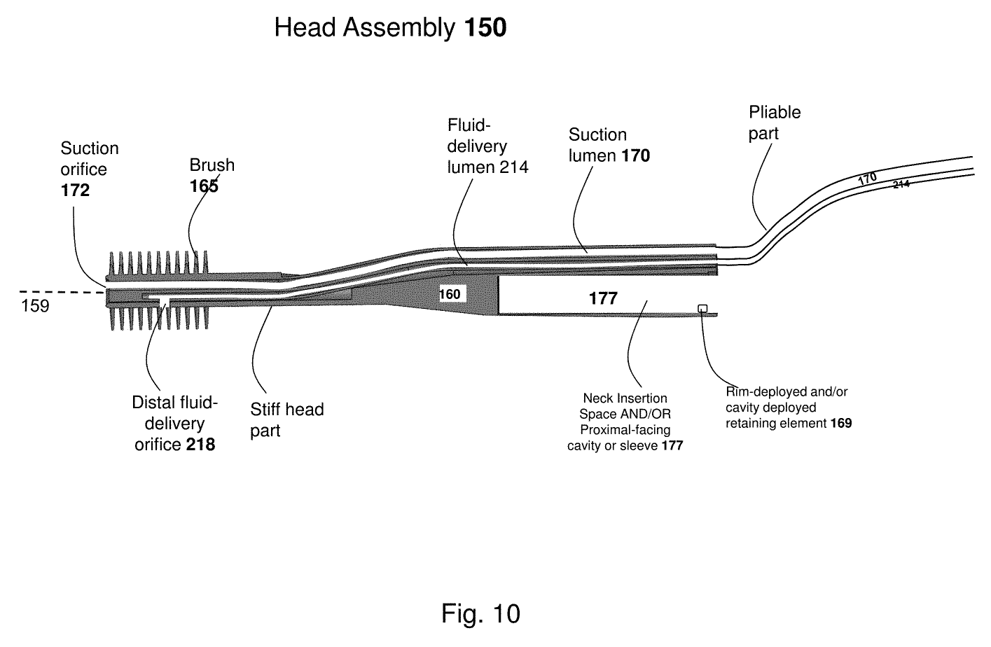

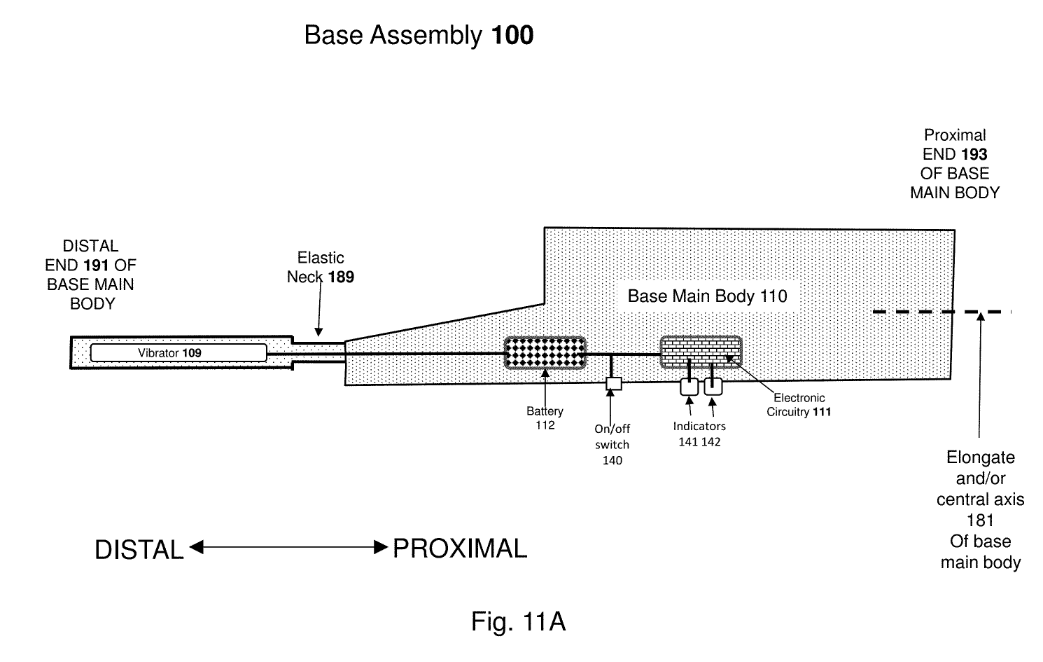

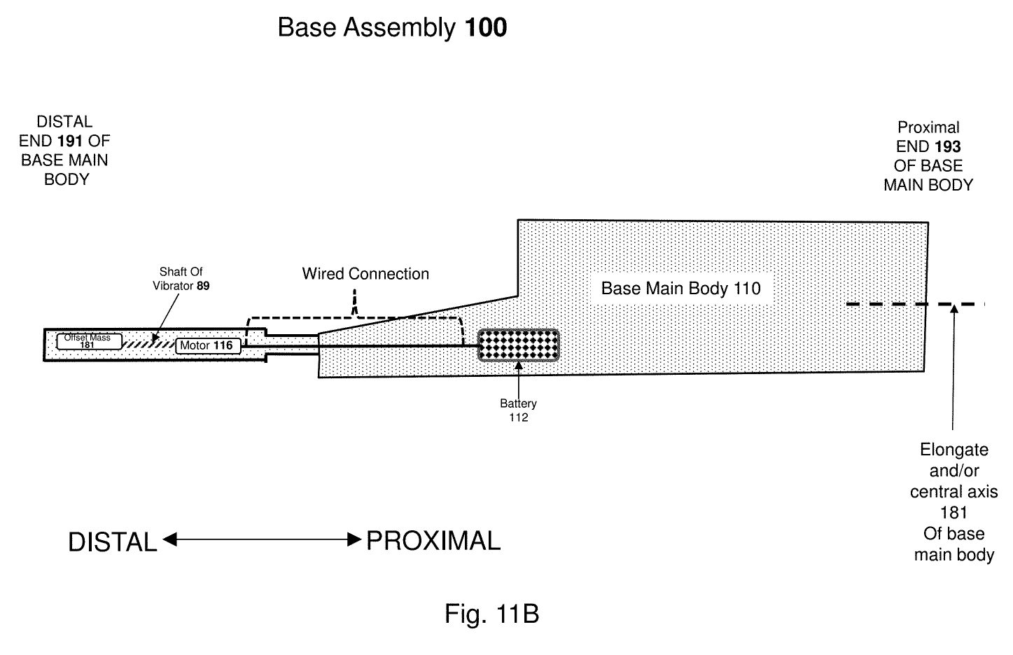

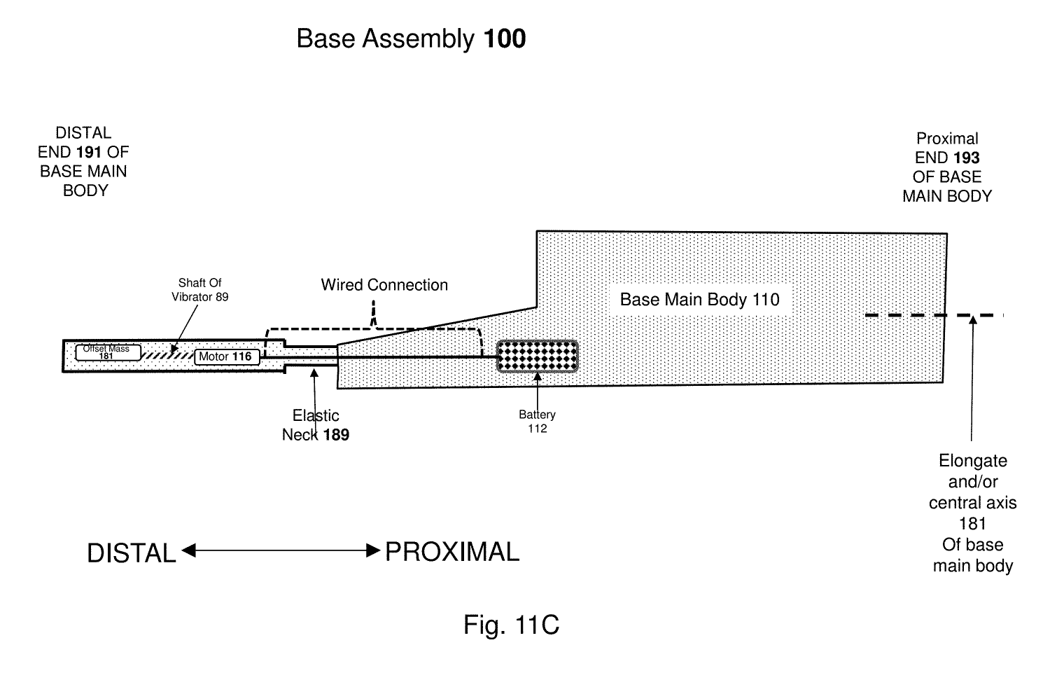

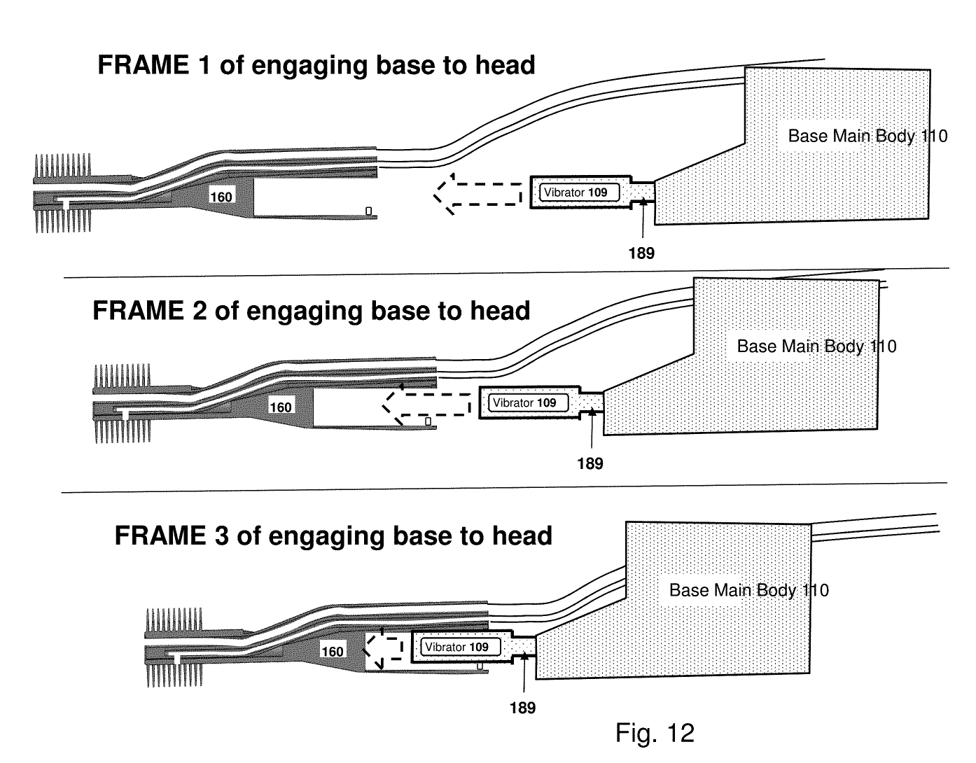

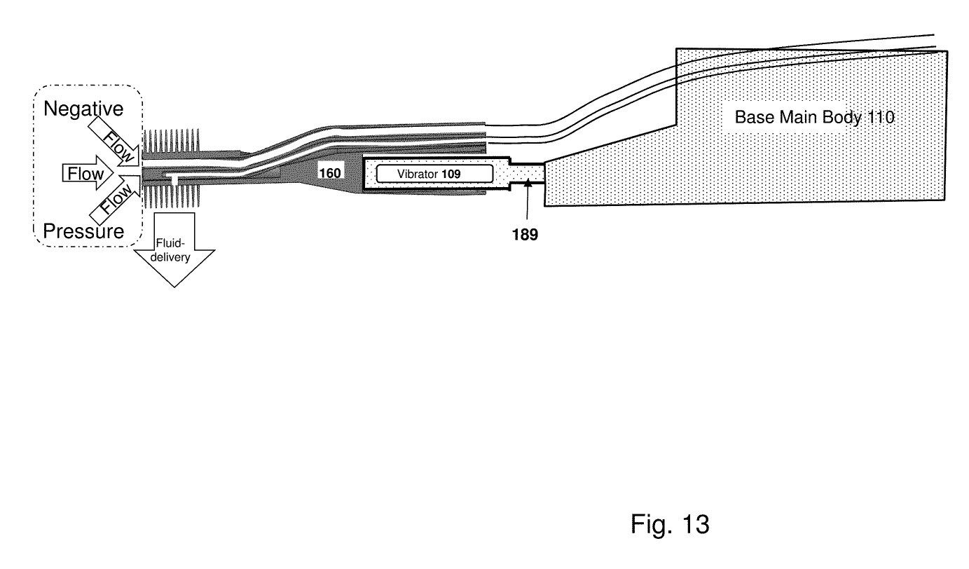

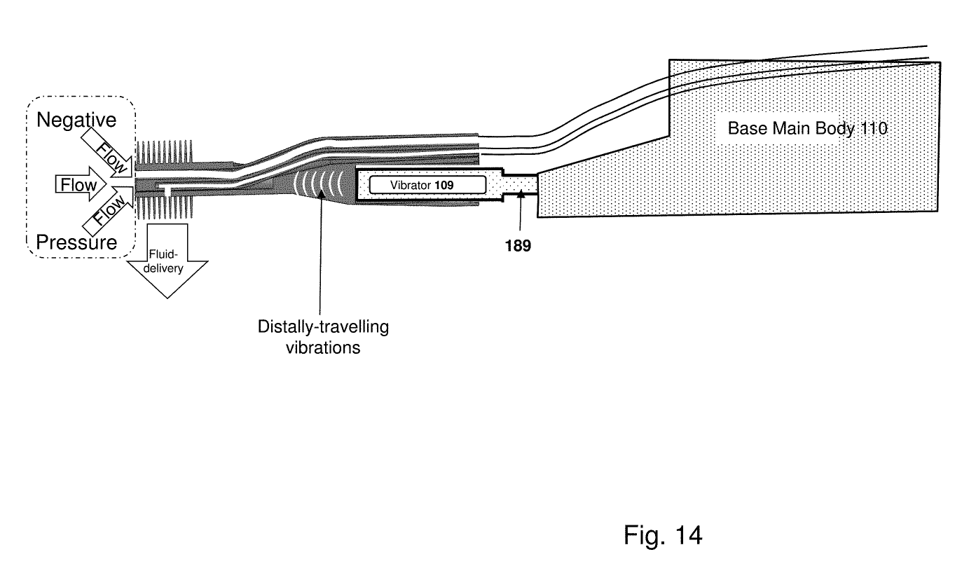

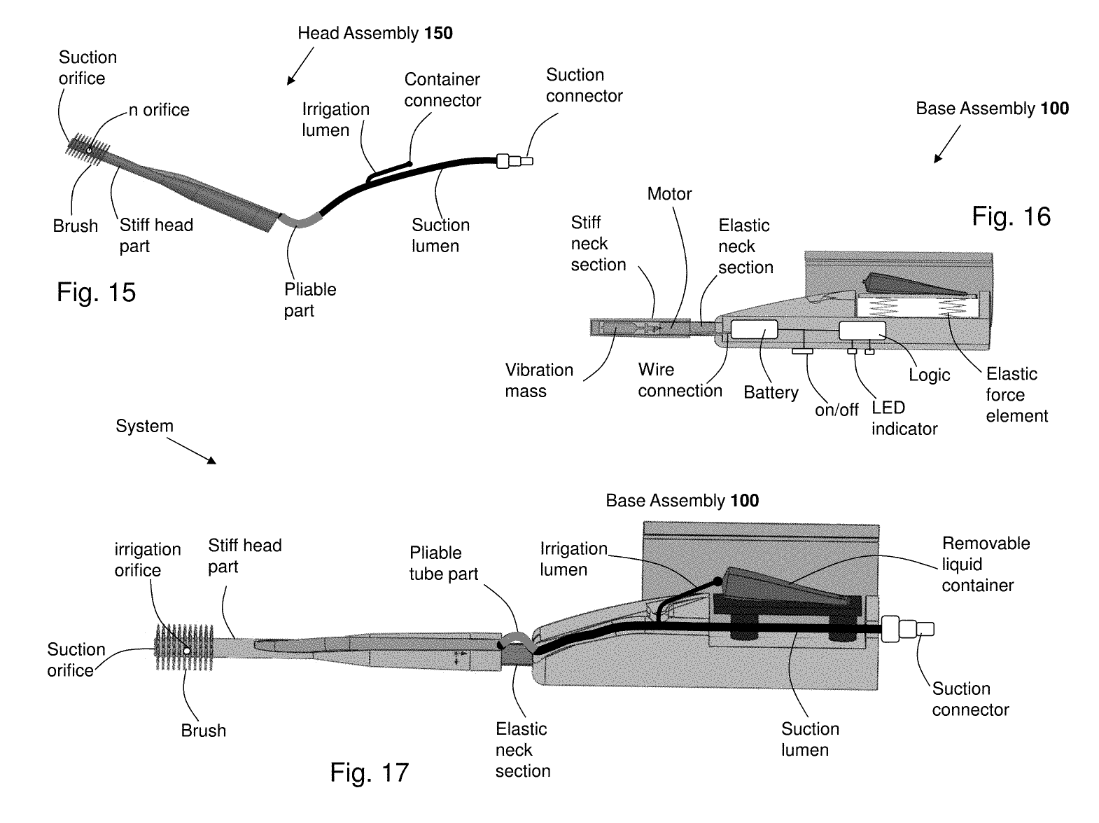

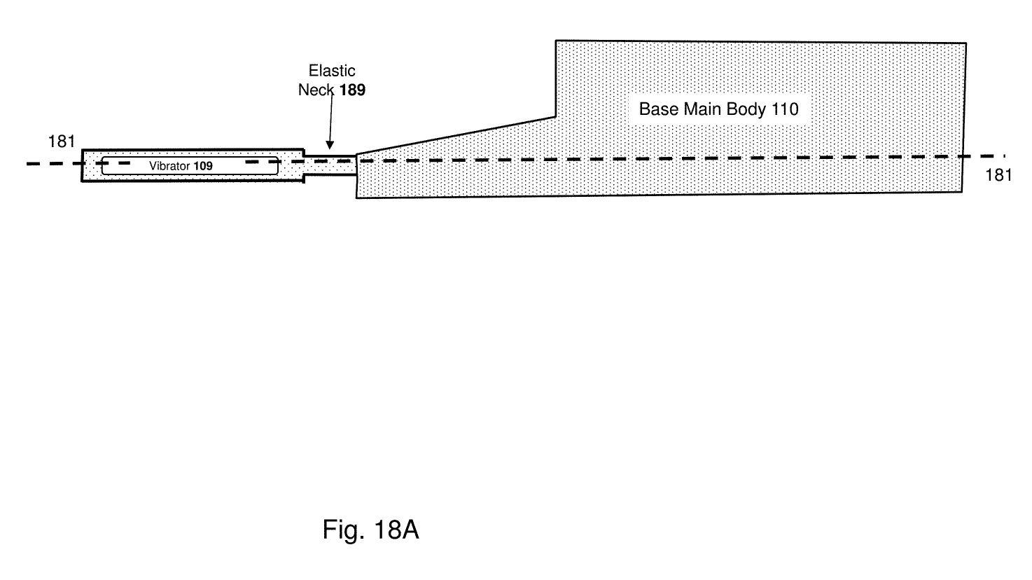

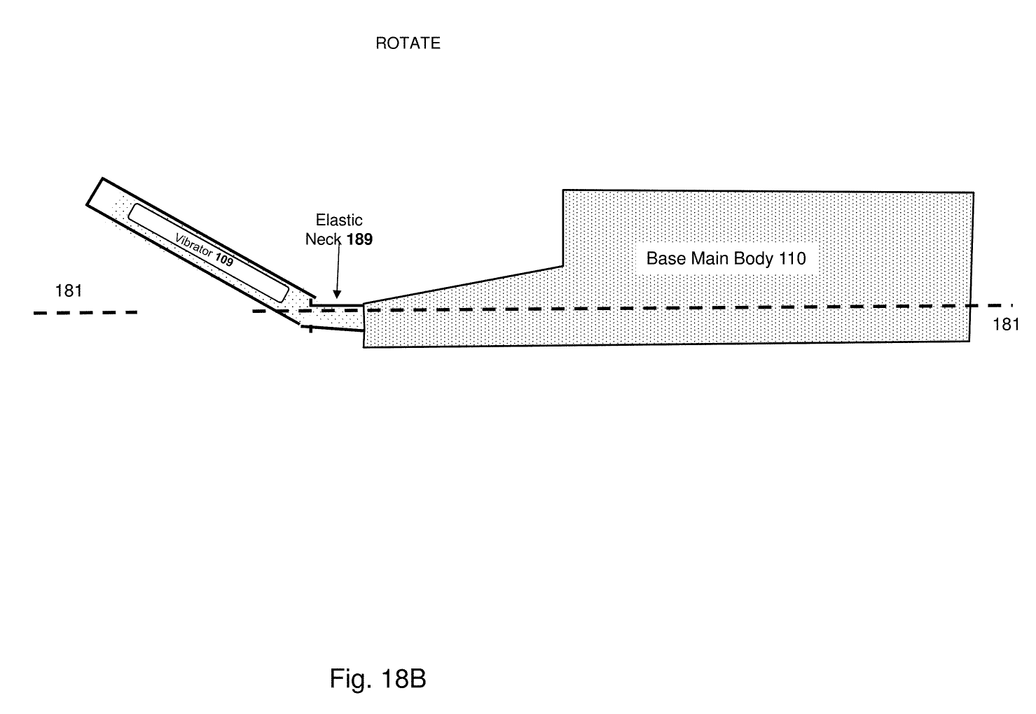

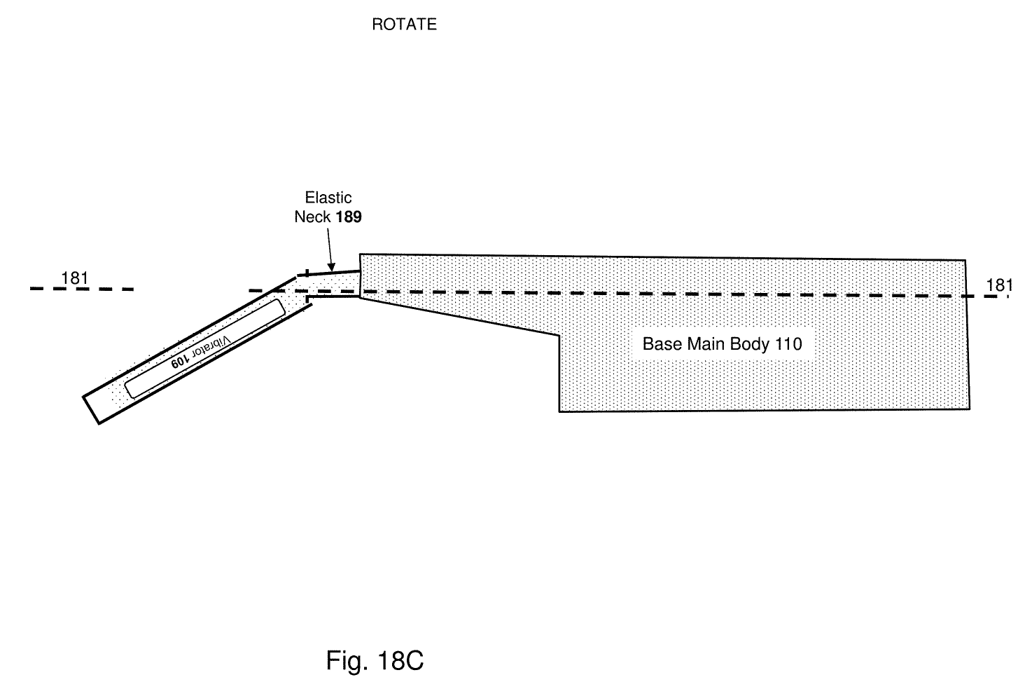

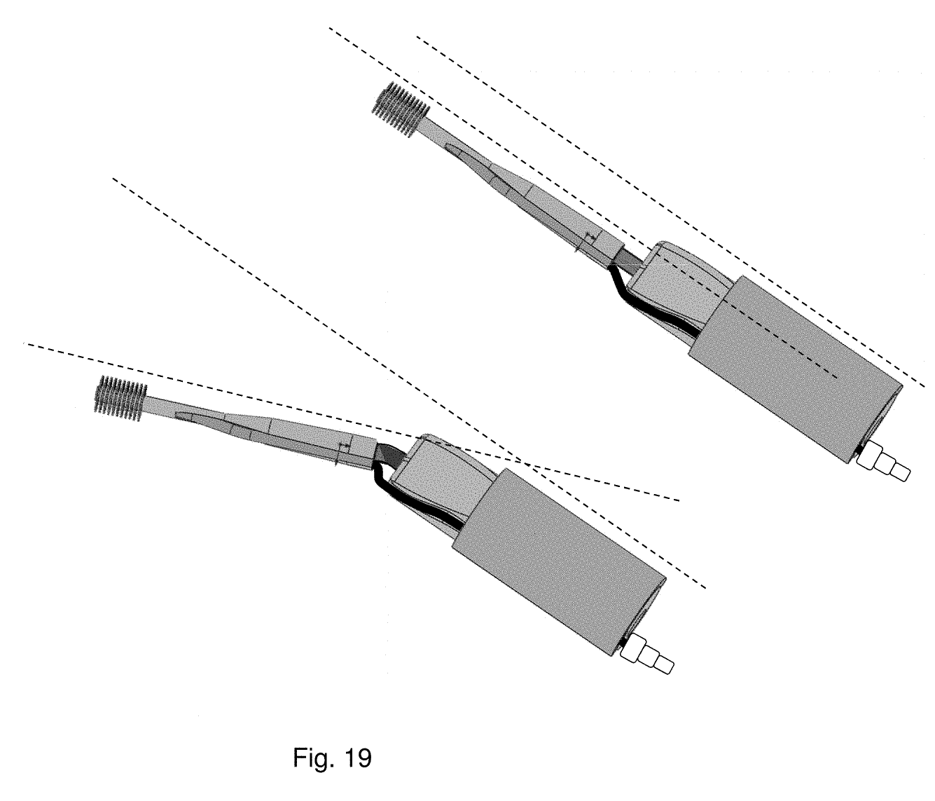

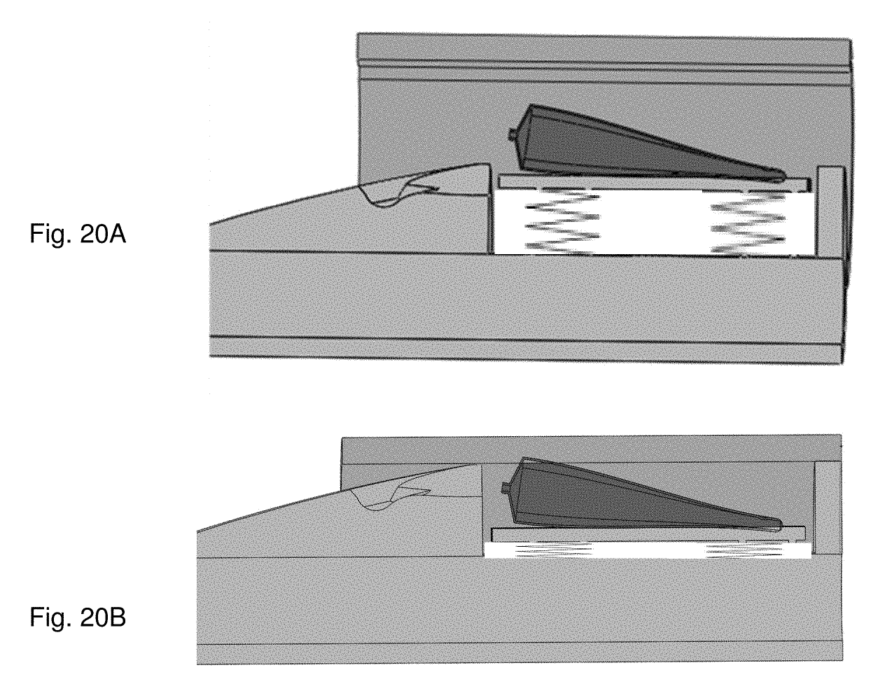

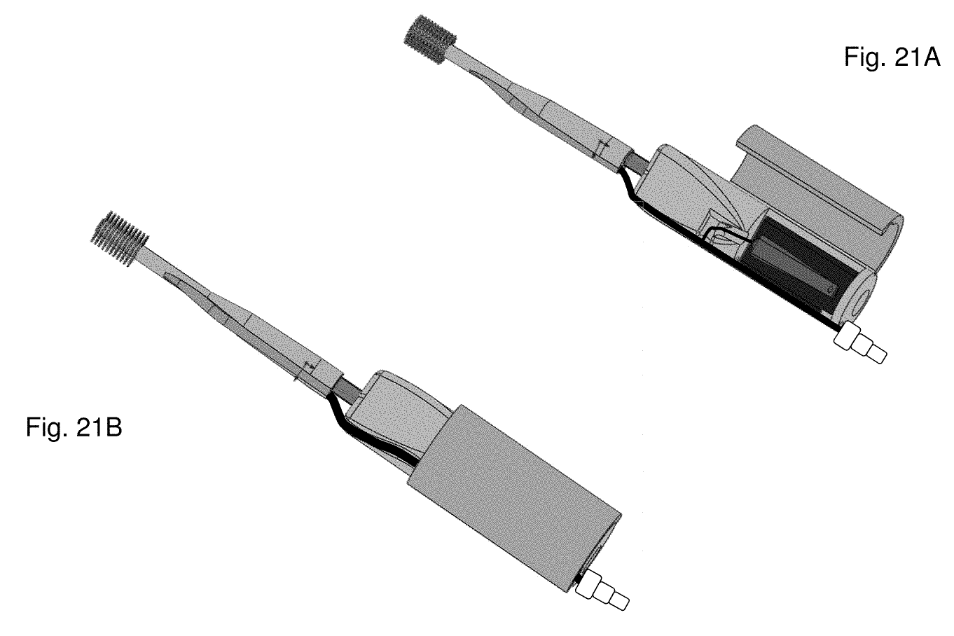

21. A system comprising:
a. An elongate electric toothbrush device (e.g. having head and main body as in the drawings or even a one-piece toothbrush) having a toothbrush body (e.g. the toothbrush body comprises head 160 and base 110 main bodies that are detachably attachable to each other or it could be a one-piece body), an electric motor deployed on or in the toothbrush body and a brush (e.g. sideways-oriented) deployed on the toothbrush body at a distal end thereof, the motor and brush being mechanically coupled to each other so that, when the motor is on, operation of the motor drives rotation and/or vibration of the toothbrush, the electric toothbrush defining an elongate axis;
b. An optional suction lumen oriented along the elongate axis and having a distal lumen located at a distal end of the toothbrush body; and
c. timing circuitry configured to measure an elapsed-time-since-most-recent-operation since the motor was last on to drive rotation and/or vibration of the brush; and
d. an electronically operated display assembly (e.g. attached to and/or deployed onto and/or mounted on—e.g. to main body 160 or to main body 110 (e.g. for the example of FIG. 1A where the display assembly comprises indicators 141, 142) or to a body of a one-piece toothbrush) having first and second display modes; and
e. display-control circuitry configured to cause the display assembly to operate in the first or second display modes according to an elapsed-time-since-most-recent-operation, as measured by the timing circuitry (e.g. since the motor was last on to drive rotation and/or vibration of the brush)

22. The system of claim 21 wherein the display assembly comprises a red LED and a green LED such that (i) when the display assembly is in the first display mode the red LED is on and the green LED is off and (ii) when the display assembly is in the first display mode the red LED is off and the green LED is on.

23. The system of any preceding claim wherein the display-control circuitry causes the display assembly to perform a mode transition from the first to the second display modes to the second of the display modes in response to the elapsed-time-since-most-recent-operation exceeding a pre-determined threshold value.

24. The method of claim 23 wherein the pre-determined threshold value is at least 2 hours or at least 4 hours or at least 6 hours and/or at most 24 hours or at most 12 hours or at most 10 hours.

25. The system of any preceding claim further comprising a user control for turning on or turning off the electrical motor and wherein the timing circuitry detects a change of state of the user control.

26. The system of claim 25 wherein the user control is a mechanical switch having first and second switch-states and the timing circuitry measures an elapsed time since the user control was in a given one of the switch-states configured to cause the motor to operate.

27. The system of any preceding claim wherein the toothbrush body comprises a head body to which the brush is attached and a base portion, wherein (i) the base portion has a battery or battery compartment that is electrically wired to the motor to provide power thereto; and (ii) the head portion is detachably attachable to the base portion.

28. The system of claim 27 wherein the motor is on or in the base portion (e.g. buried inside the base) and is electrically wired to the battery or battery compartment even when the head portion is detached from the base portion.

29. The system of claim 27 wherein the motor is on or in the head portion (e.g. buried inside the head) and is electrically wired to the battery or battery compartment only when the head portion is attached to the base portion.

30. The system of any of claims 27-29 wherein the battery or battery compartment is rigidly attached to the timing circuitry, the display assembly and/or the display-control circuitry even when the head portion is detached from the base portion.

31. The system of any preceding claim wherein the electric motor has a shaft and/or is mechanically coupled to a shaft having an offset (non-symmetric) mass attached to the shaft. [e.g. an Eccentric Rotating Mass vibration motor, (or ERM, also known as a pager motor is a DC motor with an offset (non-symmetric) mass attached to the shaft]

32. The system of claim 31 wherein the motor is within the base and the offset mass is within the head.

33. The system of claim 31 wherein both the motor and the offset mass are within the head.

34. A toothbrush system comprising:
f. an electric toothbrush device including (i) a toothbrush body defining a central and/or elongate axis; and (ii) a brush 165 having a plurality of toothbrush bristles extending from the toothbrush body;
g. a sponge layer mounted over a portion of the toothbrush body such that:
i. at least some of the toothbrush bristles extending from the toothbrush body subsequently extend through the sponge layer and have an upper portion above the sponge layer; and/or
ii. an orientation axis 196 of toothbrush 165 and a portion of the sponge layer face to the same side of the toothbrush; and/or
iii. at least a portion of the sponge layer is mounted onto a bristle-void region of the toothbrush body such that at least some toothbrush bristles of brush 165 are:
A. adjacent to the bristle-void-region-mounted portion of the sponge layer;
B. oriented substantially parallel to a surface vector of the bristle-void-region-mounted portion of the sponge layer; and
C. opposite sides of bristle-void-region-mounted portion of the sponge layer;
c. A suction lumen oriented along the central and/or elongate axis of the toothbrush both and having a distal lumen located at a distal end of the toothbrush body.

35. The system of claim 34 further comprising an electrical motor for driving motion of the toothbrush bristles.

36. The system of claim 34 further comprising an electrical motor for driving motion of the toothbrush bristles.

37. The system of claim 34 further comprising an electrical motor for driving motion of the toothbrush bristles.

38. The system of claim 34 further comprising an electrical motor for driving motion of the toothbrush bristles.

39. The system of claim 34 further comprising an electrical motor for driving motion of the toothbrush bristles.

40. The system of any of claims 34-35 further comprising:
d. timing circuitry configured to measure an elapsed-time-since-most-recent-operation since the motor was last on to drive rotation and/or vibration of the brush; and
e. an electronically operated display assembly (e.g. attached to and/or deployed onto and/or mounted on—e.g. to main body 160 or to main body 110 (e.g. for the example of FIG. 1A where the display assembly comprises indicators 141, 142) or to a body of a one-piece toothbrush) having first and second display modes; and
f. display-control circuitry configured to cause the display assembly to operate in the first or second display modes according to an elapsed-time-since-most-recent-operation, as measured by the timing circuitry (e.g. since the motor was last on to drive rotation and/or vibration of the brush)

41. A toothbrush system comprising:
a. an elongated toothbrush main body defining a main body elongate axis;
b. a brush comprising a plurality of toothbrush bristles, the brush being mounted to the toothbrush main body at a distal end thereof;
c. a suction lumen having a distal portion that (i) is disposed within or alongside the toothbrush main body; (ii) defines a suction-lumen-distal-orifice at a distal end of the suction lumen, the suction-lumen-distal-orifice being disposed at the distal end of the toothbrush main body;
d. an onboard sensor that is (i) mechanically coupled to toothbrush main body; and (ii) for detecting a current level or activity/passivity of the toothbrush;
e. onboard timing circuitry configured to measure an elapsed-time since activity decrease (ETSAD), the ETSAD being an elapsed time since the level of activity/passivity of the toothbrush, as sensed by the onboard sensor, has decreased;
f. an electronically operated display assembly (e.g. attached to and/or deployed onto and/or mounted on—e.g. to main body 160 or to main body 110 (e.g. for the example of FIG. 1A where the display assembly comprises indicators 141, 142) or to a body of a one-piece toothbrush) having first and second display modes; and
g. display-control circuitry for regulating operation of the display assembly in the first or second display modes according to the ETSAD, as measured by the onboard timing circuitry.

42. The system of claim 41 wherein display-control circuitry regulates operation of the display assembly so as to transition the display assembly from the first state mode to the second state mode only after the elapsed time, as measured by the onboard timing circuitry, exceeds a threshold level that is greater than 3 hours.

43. A toothbrush system comprising:
a. an elongated toothbrush main body defining a main body elongate axis;
b. a brush comprising a plurality of toothbrush bristles, the brush being mounted to the toothbrush main body at a distal end thereof;
c. a suction lumen having a distal portion that (i) is disposed within or alongside the toothbrush main body; (ii) defines a suction-lumen-distal-orifice at a distal end of the suction lumen, the suction-lumen-distal-orifice being disposed at the distal end of the toothbrush main body;
d. an onboard sensor that is (i) mechanically coupled to toothbrush main body; and (ii) for detecting a current state of the toothbrush system;
e. onboard timing circuitry configured to measure an elapsed-time since a state-change as detected by the onboard sensor;
f. an electronically operated display assembly (e.g. attached to and/or deployed onto and/or mounted on—e.g. to main body 160 or to main body 110 (e.g. for the example of FIG. 1A where the display assembly comprises indicators 141, 142) or to a body of a one-piece toothbrush) having first and second display modes; and
g. display-control circuitry for regulating operation of the display assembly in the first or second display modes according to the elapsed time, the display-control circuitry configured to transition the display assembly from the first state mode to the second state mode only after the elapsed time, as measured by the onboard timing circuitry, exceeds a threshold level that is greater than 3 hours.

44. The system of any of claims 41-43 wherein the toothbrush system is a manual toothbrush lacking a motor.

45. The system of any of claims 41-43 wherein (i) the toothbrush system includes an onboard electrical motor configured for driving motion of the toothbrush-bristle-comprising brush, (ii) the onboard sensor senses a shut-down of the onboard electrical motor or a reduction in operating power thereof; (iii) the timing circuitry measures an elapsed time since shutdown of the onboard electrical motor; and (iv) the display-control circuitry regulates operation of the display state according to the elapsed time since the shutdown of the electrical motor or the reduction in operating power thereof.

46. The system of any preceding claim wherein the timing circuitry measures an elapsed time since a change in an operation state of the suction lumen (e.g. flow of matter through the suction lumen, for example, in a proximal direction) and the display-control circuitry regulates operation of the display state according to the elapsed time since the change in the state of the suction lumen.

47. The system of any preceding claim (i) further comprising a fluid-delivery lumen, at least a portion of which is alongside the suction lumen and defining a distal fluid-delivery orifice disposed at the distal end of the toothbrush main body; (ii) the timing circuitry measures an elapsed time since fluid is forced into the fluid-delivery lumen from a proximal end thereof and/or an elapsed time since fluid flows in a distal direction through the fluid-delivery lumen; and (iii) the display-control circuitry regulates operation of the display state according to the elapsed time since the flow of fluid and/or forcing of liquid into the fluid-delivery lumen.

48. The toothbrush system of any preceding claim wherein the onboard sensor is deployed within the toothbrush main body.

49. The toothbrush system of any preceding claim wherein the onboard sensor is directly or indirectly attached to the toothbrush main body.

50. A toothbrush system comprising:
h. An elongate electric toothbrush device (e.g. having head and main body that are detachably attached to each other or a toothbrush device having a one-piece toothbrush body) having a toothbrush body (e.g. the toothbrush body comprises head 160 and base 110 main bodies that are detachably attachable to each other or it could be a one-piece body), an electric motor deployed on or in the toothbrush body and a brush (e.g. sideways-oriented) deployed on the toothbrush body at a distal end thereof, the motor and brush being mechanically coupled to each other so that, when the motor is on, operation of the motor drives rotation and/or vibration of the toothbrush, the electric toothbrush defining an elongate axis;
i. An optional suction lumen oriented along the elongate axis and having a distal lumen located at a distal end of the toothbrush body; and
j. timing circuitry configured to measure an elapsed-time-since-most-recent-operation since the motor was last on to drive rotation and/or vibration of the brush; and
k. an electronically operated display assembly (e.g. attached to and/or deployed onto and/or mounted on—e.g. to main body 160 or to main body 110 (e.g. for the example of FIG. 1A where the display assembly comprises indicators 141, 142) or to a body of a one-piece toothbrush) having first and second display modes; and
l. display-control circuitry configured to cause the display assembly to operate in the first or second display modes according to an elapsed-time-since-most-recent-operation, as measured by the timing circuitry (e.g. since the motor was last on to drive rotation and/or vibration of the brush)

51. The system of any previous claim wherein the display assembly comprises a display screen.

52. The toothbrush system of any preceding claim wherein an elongated toothbrush main body is a one-piece main body.

53. The toothbrush system of any of claims 41-52 wherein the elongated toothbrush main body comprises a head portion and a base portion that are detachably attached to each other.

54. The toothbrush system of any preceding claim wherein (i) a body of the toothbrush comprises base portion and a head portion detachably attached to the base portion; and
(ii) the timing circuitry and/or display-control circuitry and/or electronically operated display assembly is powered by a battery disposed on or within the base portion.

55. The system of any preceding claim wherein the display-control circuitry causes the display assembly to perform a mode transition from the first to the second display modes to the second of the display modes in response to the elapsed-time-since-most-recent-operation exceeding a pre-determined threshold value.

56. The method of claim 55 wherein the pre-determined threshold value is at least 2 hours or at least 4 hours or at least 6 hours and/or at most 24 hours or at most 12 hours or at most 10 hours.

57. The system of any preceding claim further comprising a user control for turning on or turning off the electrical motor and wherein the timing circuitry detects a change of state of the user control.

58. The system of claim 57 wherein the user control is a mechanical switch having first and second switch-states and the timing circuitry measures an elapsed time since the user control was in a given one of the switch-states configured to cause the motor to operate.

59. The system of any preceding claim wherein the toothbrush body comprises a head body to which the brush is attached and a base portion, wherein (i) the base portion has a battery or battery compartment that is electrically wired to the motor to provide power thereto; and (ii) the head portion is detachably attachable to the base portion.

60. The system of claim 59 wherein the motor is on or in the base portion (e.g. buried inside the base) and is electrically wired to the battery or battery compartment even when the head portion is detached from the base portion.

61. The system of claim 59 wherein the motor is on or in the head portion (e.g. buried inside the head) and is electrically wired to the battery or battery compartment only when the head portion is attached to the base portion.

62. The system of any of claims 59-61 wherein the battery or battery compartment is rigidly attached to the timing circuitry, the display assembly and/or the display-control circuitry even when the head portion is detached from the base portion.

63. The system of any preceding claim wherein the electric motor has a shaft and/or is mechanically coupled to a shaft having an offset (non-symmetric) mass attached to the shaft. [e.g. an Eccentric Rotating Mass vibration motor, (or ERM, also known as a pager motor is a DC motor with an offset (non-symmetric) mass attached to the shaft]

64. The system of claim 31 wherein the motor is within the base and the offset mass is within the head.

65. The system of claim 31 wherein both the motor and the offset mass are within the head.

66. The system of any previous claim wherein the suction lumen oriented along the central and/or elongate axis of the toothbrush body and has a distal lumen located at a distal end of the toothbrush body.

67. The system of any previous claim further comprising a sponge layer mounted over a portion of the toothbrush body such that:
m. at least some of the toothbrush bristles extending from the toothbrush body subsequently extend through the sponge layer and have an upper portion above the sponge layer; and/or
ii. an orientation axis 196 of toothbrush 165 and a portion of the sponge layer face to the same side of the toothbrush; and/or
iii. at least a portion of the sponge layer is mounted onto a bristle-void region of the toothbrush body such that at least some toothbrush bristles of brush 165 are:
A. adjacent to the bristle-void-region-mounted portion of the sponge layer;
B. oriented substantially parallel to a surface vector of the bristle-void-region-mounted portion of the sponge layer; and
C. opposite sides of bristle-void-region-mounted portion of the sponge layer;

68. An oral care system comprising:
a. an electrical motor 116;
b. a base assembly 100 comprising:
i. an elongated base-assembly main body 110 defining an elongate axis 181; and/or
ii. a battery or a battery compartment optionally including electrical contacts for a battery, the battery and/or the battery compartment being electrically wired to the electrical motor 116;
c. a head assembly 150, the head assembly comprising:
i. an elongated head-assembly main body 160 defining an elongate axis 159 thereof;
ii. a sideways-facing brush 165 mounted to the head-assembly main body 160 in a distal half thereof;
iii. a suction lumen 170 defining a distal suction-orifice 172, the suction lumen comprising:
A. a distal portion 270A disposed within or alongside the head-assembly main body 160 to longitudinally span a majority thereof; and
B. a proximal portion 270B that is located proximal to the distal portion 270A,
the head assembly 150 being detachably attachable to the base assembly such that when the head and base assemblies 150, 100 are attached to each other:
I. the head-assembly main body 160 is disposed distal to the base-assembly main-body 110; and
ii. the brush is mechanically coupled to the motor 115 so that operation of the motor induces motion of the sideways-facing brush 165;
wherein:
i. both the distal 270A and proximal 270B portions of the suction lumen may be completely brought out of contact from the base assembly main body 110 while remaining attached to each other and to the head-assembly main body 160.

69. The system of claim 68 wherein when the head and base assemblies 150, 100 are attached to each other:
A. the proximal 270B portion is within and/or disposed alongside the base assembly main body 110 and longitudinally spans at least a majority thereof; and/or
B. an interior of an entirety of the suction lumen 170 is liquid-sealed away from the base assembly main body 110; and/or
C. the base assembly main body 110 is in restraining contact with the proximal portion 270B of the suction lumen 170 via a location 137 disposed on the proximal half of the base assembly main body, so as to restrain at least sideways motion of the suction lumen 170 away from the base assembly main body 110 at the location 137.

70. A head assembly for an electrical toothbrush device, the head assembly comprising:
a. an elongated head-assembly main body 160 defining an elongate axis 159 thereof and having a proximal-facing recess;
b. a sideways-facing brush 165 comprising toothbrush bristles mounted to the head-assembly main body 160 in a distal half thereof;
c. suction lumen 170 and fluid-delivery lumen 214 respectively defining suction 172 and fluid-delivery 218 distal orifices, each of the suction and fluid-delivery lumens having:
i. respective distal portions that are each disposed within or alongside the head-assembly main body 160 to longitudinally span a majority of the head-assembly main body 160; and
ii. respective proximal portions that are each disposed proximal to their distal counterparts; and
d. a fluid-storage reservoir containing cleaning fluid attached to the fluid-delivery lumen at a proximal end thereof and in communication (e.g. sealed fluid communication) with the fluid-delivery orifice via fluid-delivery lumen.

71. The head assembly of claim 70 wherein a volume of the fluid-storage reservoir between 2 cc and 20 cc, between 5 cc and 10 cc

72. The head assembly of any preceding claim wherein a ratio between a cross section of the suction distal-orifice and the fluid-delivery orifice is at least 1 or at least 1.25 or at least 1.5 or at least 1.75 or at least 2.

73. The head assembly of any preceding claim wherein a ratio between a cross section of the suction lumen and the fluid-delivery lumen is at least 1 or at least 1.25 or at least 1.5 or at least 2 or at least 3 or at least 4.

74. The head assembly of any preceding claim wherein the suction distal-orifice and the fluid-delivery distal-orifice are oriented away from each other by at least 20 degrees or at least 45 degrees or at least 60 degrees or at least 90 degrees

75. The head assembly of any preceding claim wherein the suction distal-orifice faces in direction substantially parallel to the elongate axis 159 within a 30 degree tolerance.

76. The head assembly of any preceding claim wherein: (i) at least respective sub-portions of the proximal portions of the suction and fluid-delivery lumens are disposed alongside each other; and (ii) at a fork location that is proximal to each of the sub-portions, the suction and fluid-delivery lumens distally diverge from each other.

77. The head assembly of any preceding claim wherein the fork location is proximal to a center of the proximal-facing recess.

78. A toothbrush comprising:
a. a [one-piece or multi-piece] elongated toothbrush body defining elongate axis 181;
b. a sideways-facing brush 165 comprising toothbrush bristles mounted to the head-assembly main body 160 in a distal half thereof;
c. a suction lumen 170 defining a distal suction-orifice 172, at least a portion of the suction lumen 170 being disposed within or alongside the head-assembly main body 160 [e.g. to longitudinally span a majority thereof]; and
d. a vibrator device mounted in or on the elongated toothbrush body 110, the vibrator device including:
G. an electrical motor 116;
H. a shaft that is part of the electrical motor and/or mechanically coupled to the electrical motor;
I. an offset/non-symmetric mass attached to the shaft so that operation of the electrical motor causes the offset/non-symmetric mass to rotate around an elongate axis of the shaft to product vibrations,
the shaft of the vibrator device being aligned with the elongate axis 181 of the main body and disposed in or on the elongated toothbrush body so as to induce vibrations of the sideways-facing brush 165.

79. A head assembly for an electrical toothbrush device, the head assembly comprising:
a. an elongated head-assembly main body 160 defining an elongate axis 159 thereof and having a proximal-facing recess;
b. a sideways-facing brush 165 comprising toothbrush bristles mounted to the head-assembly main body 160 in a distal half thereof;
c. suction lumen 170 and fluid-delivery lumen respectively defining suction 172 and fluid-delivery distal orifices, each of the suction and fluid-delivery lumens having:
i. respective 270A, distal portions that are each disposed within or alongside the head-assembly main body 160 to longitudinally span a majority of the head-assembly main body 160; and
ii. respective 270B, proximal portions that are each disposed proximal to their distal counterparts; and
wherein:
A. a thickness ratio between a cross section of the suction distal-orifice and the fluid-delivery orifice is at least 1 or at least 1.25 or at least 1.5 or at least 1.75 or at least 2;
B. a length ratio between respective lengths of the suction lumen 170 and fluid-delivery lumen is at least 1.25 or at least 1.5 or at least 1.75 or at least 2 or at least 3 or at least 4 or at least 5]

80. A base assembly of an oral care system comprising:
i. an elongated base-assembly main body 110, at least a portion of which is elastic, the elongated base-assembly main body 110 defining an equilibrium-configuration elongate axis 181; and
ii. a vibrator device mounted in or on the elongated base-assembly main body 110, the vibrator device including:
J. an electrical motor 116;
K. a shaft that is part of the electrical motor and/or mechanically coupled to the electrical motor;
L. an offset/non-symmetric mass attached to the shaft so that operation of the electrical motor causes the offset/non-symmetric mass to rotate around an elongate axis of the shaft to product vibrations,
the shaft of the vibrator device being aligned with the elongate axis 181 of the main body and the offset/non-symmetric mass located at a distal end of the base-assembly main body 110, at least a portion of the elongated base assembly main body being sufficiently elastic so that:
C. when the elongated base-assembly main body 110 is the equilibrium configuration, line-segment between (A) fixed point on a proximal half of the elongated base-assembly main body 110 and (B) the offset/non-symmetric mass is aligned with the elongate axis 181 of the elongated base-assembly main body 110; and
D. the elongated base-assembly main body 110 elastically bends without breaking to allow a direction of the line-segment to deviate from a direction of the equilibrium-configuration elongate axis 181 by at least 10 degrees or at least 20 degrees or at least 30 degrees.

81. The system of claim 80 further comprising a lumen restrainer disposed on a proximal half of the base-assembly main-body 110

82. A method comprising employing the base assembly of any of claims 14-15 to drive vibrational motion of a toothbrush.

83. The method of claim 16 further comprising simultaneous with the driving of the vibrational motion, suctioning matter through a suction lumen.

84. The method of claim 17 wherein the suction lumen is aligned with the equilibrium-configuration elongate axis 181.
